(19) United States
(12) Patent Application Publication
(10) Pub. No.: US 2006/0172094 A1
(43) Pub. Date: Aug. 3, 2006

(54) Image transfer media and methods of using the same

(76) Inventors: Ming-Kun Shi, Arcadia, CA (US); Dong-Tsai Hseih, Arcadia, CA (US); Sriram Venkatasanthanam, Chino Hills, CA (US); Ramin Heydarpour, Beverly Hills, CA (US)

Correspondence Address: KRIEGSMAN & KRIEGSMAN, 665 Franklin Street, Framingham, MA, 01702, US

(21) Appl. No.: 11/288,021

(22) Filed: Nov. 28, 2005

Related U.S. Application Data
(60) Provisional application No. 60/648,345, filed on Jan. 28, 2005.
(60) Provisional application No. 60/648,346, filed on Jan. 28, 2005.

(51) Int. Cl. B41M 5/00

(52) U.S. Cl. 428/32.24

(57) ABSTRACT

An image transfer medium for transferring a printed image to a substrate. In a preferred embodiment, the image transfer medium is particularly well-suited for use in transferring an ink-jet printed image to a white substrate, such as a white T-shirt, and comprises an image receiving laminate and an image protecting laminate. The image receiving laminate preferably comprises a base, a release coating coated directly on a surface of the base, a thermoplastic layer coated directly on the release coating, and an ink-receptive layer coated directly on the thermoplastic layer. The image protecting laminate preferably comprises a base, a release coating coated directly on a surface of the base, and a thermoplastic layer coated directly on the release coating. In one possible use, an image is reverse-printed on the ink-receptive layer. The thermoplastic layer of the image protecting laminate is heat-bonded to the substrate, and its release liner is peeled away. The image is then placed on top of the bonded thermoplastic layer, and heat and pressure are applied to the release liner of the image receiving laminate until the ink-receptive layer and the image bond to the bonded thermoplastic layer. The remaining release liner is then peeled away.

### CROSS-REFERENCE TO RELATED APPLICATIONS

The present application claims the benefit under 35 U.S.C. 119(e) of U.S. Provisional Patent Application Ser. No. 60/648,345, filed Jan. 28, 2005, and U.S. Provisional Patent Application Ser. No. 60/648,346, filed Jan. 28, 2005, the disclosures of which are incorporated herein by reference.

### BACKGROUND OF THE INVENTION

The present invention relates generally to the decoration and/or labeling of articles and relates more particularly to the decoration and/or labeling of articles using image transfer media.

It is often desirable to decorate an article for reasons of self-expression or aesthetics and/or to label the article with information of the type including, but not limited to, price, size, a designation of source, instructions for use and care, etc. For certain articles, such decoration and/or labeling may be effected by printing such subject matter directly onto the article. However, many articles are not well-suited for direct printing. Moreover, with the widespread availability of computers that are capable of customizing and editing textual and/or non-textual matter, it has become increasingly popular to print such subject matter onto an image transfer medium and, thereafter, to transfer the printed matter from the image transfer medium to the article.

Referring now to FIG. 1, there is schematically shown a conventional image transfer medium of the type that is used to transfer an ink-jet printed image onto a light-colored (i.e., white) substrate, said conventional image transfer medium being represented generally by reference numeral 11.

Image transfer medium 11 includes a release liner 13, a thermoplastic layer 15 and an ink-receptive layer 17. Release liner 13 consists of a base 19 and a release coating 21, release coating 21 being coated directly onto top of base 19. Base 19 is typically paper or a plastic film, and release coating 21 is typically silicone or wax. Thermoplastic layer 15, which is coated directly on top of release coating 21, serves to protect the transferred image against cracking and to impart a soft, tactile property to the transferred image. In addition, depending upon whether the top surface of base 19 is smooth or textured, the bottom surface of thermoplastic layer 15 can be used to impart a glossy finish or a matte finish, respectively, to the transferred image. Thermoplastic layer 15 is typically made of cellulose or an ethylene acrylate copolymer. Ink-receptive layer 17, which is coated directly on top of thermoplastic layer 15, serves to receive the ink-jet printed image and to bond to the light-colored substrate. Ink-receptive layer 17 typically comprises a polymeric binder and a plurality of polymeric or inorganic particles, the particles being dispersed and held in place by the binder. The dispersed particles form interstitial pores or voids for wicking and retaining the printed ink.

Release liner 13 cannot be separated from thermoplastic layer 15 and ink-receptive layer 17 prior to image transfer because ink-receptive layer 17 is friable.

Referring now to FIG. 2, there is schematically shown the manner in which image transfer medium 11 may be used to transfer an image onto a light-colored substrate, such as a white T-shirt. First, using an ink-jet printer (not shown), an image 23 containing textual and/or non-textual matter is printed onto the exposed, top surface of ink-receptive layer 17. For reasons to become apparent below, image 23 is reverse-printed (i.e, printed as a mirror image of how one wishes the image to appear on the light-colored substrate) onto ink-receptive layer 17. Image 23 and the remaining exposed area of ink-receptive layer 17 are then placed in direct contact with a light-colored substrate LS, and a household iron I, typically at a temperature of about 140° C., is applied to release liner 13 for about 15 to 30 seconds or until sufficient heat and pressure are transmitted to ink-receptive layer 17 to cause it to bond to light-colored substrate LS. Iron I is then removed, and release liner 13 is peeled away from thermoplastic layer 15. As can be appreciated, because image 23 is sandwiched between substrate LS and ink-receptive layer 17, image 23 must be viewable through ink-receptive layer 17 and thermoplastic layer 15 after image transfer.

Referring now to FIG. 3, there is schematically shown a conventional image transfer medium of the type that is used to transfer an ink-jet printed image onto a dark-colored (i.e., non-white) substrate, said conventional image transfer medium being represented generally by reference numeral 31.

Image transfer medium 31 is similar in some respects to image transfer medium 11, the principal differences between the two image transfer media being that (i) image transfer medium 31 includes an anchorage layer 35, instead of thermoplastic layer 15, anchorage layer 35 being a heat-activated adhesive layer for bonding the image to a dark-colored substrate; and (ii) image transfer medium 31 includes a white pigment layer 37 interposed between anchorage layer 35 and ink-receptive layer 17, white pigment layer 37 providing a bright background for the printed image so as to maximize image contrast.

Referring now to FIG. 4, there is schematically shown the manner in which image transfer medium 31 may be used to transfer an image onto a dark-colored substrate, such as a non-white T-shirt. First, using an ink-jet printer (not shown), an image 39 containing textual and/or non-textual matter is printed onto the exposed, top surface of ink-receptive layer 17. Unlike the situation described above for medium 11, image 39 is not reverse-printed onto ink-receptive layer 17, but rather, is direct-printed (i.e, printed as one wishes the image to appear on the dark-colored substrate) onto ink-receptive layer 17. Next, release liner 13 is removed from the bottom of anchorage layer 35, and the bottom surface of anchorage layer 35 is then placed in direct contact with a dark-colored substrate DS. A protective parchment or silicone sheet P is then placed over image 39, and a household iron I, typically at a temperature of about 140° C., is applied to the protective sheet for about 15 to 30 seconds or until sufficient heat and pressure are transmitted to anchorage layer 35 to cause it to bond to dark-colored substrate DS. Iron I and protective sheet P are then removed.

One problem with image transfer media of the type described above is that the transferred image tends to have poor resistance to environmental conditions. For example, washing the transferred image often leads to a fading of color within the image, a peeling of the image from the substrate, a cracking of the image or a combination thereof. More specifically, in those instances where the image has been transferred to a dark-colored substrate (see FIG. 4), the top of the image is exposed and, therefore, susceptible to water degradation. Alternatively, in those instances where the image has been transferred to a light-colored substrate and the light-colored substrate has a high permeability to water, such as where the substrate is made of fabric (see FIG. 2), the bottom of the image is susceptible to water degradation from water passing through the substrate. Moreover, in addition to problems caused by washing, most of the images currently transferred are printed using organic dyestuffs, which are susceptible to color fading upon exposure to light radiation, environmental pollutants, high temperatures and humidity.

In response to the above, various approaches have been taken in an effort to protect transferred images against environmental damage. Some of these approaches have included, for example, the addition of UV-absorbers to the ink-receptive layer to provide UV protection, the inclusion in the ink-receptive layer of ink-fixative ingredients, and the use of UV- or heat-curable materials for sealing the ink-receptive layer after image printing (see, for example, U.S. Patent Application Publication Nos. US2004/0108050A1, US2004/0109959A1, US2004/0146700A1, US2003/0184636A1, US2004/0109957A1, and US2003/0044595A1, all of which are incorporated herein by reference). Thus far, the foregoing approaches have achieved only limited success.

Another problem with image transfer media of the type described above is that different printer settings are required, depending upon whether the transfer is intended for a light-colored substrate (in which case reverse printing is used) or for a dark-colored substrate (in which case direct printing is used). These different printer settings often create confusion for users, who, in many cases, forget to set the printer correctly. Moreover, certain older printers do not even have a reverse printing functionality.

Furthermore, in those instances in which the image is being transferred to a dark-colored substrate, the image is positioned face-up during transfer, and a sheet of parchment or silicone paper is typically placed over the image to protect the image as heat is applied from a household iron or the like. However, as can be appreciated, such a need for parchment or silicone paper adds cost to the transfer process with no added benefits.

Lastly, in those instances in which the image is being transferred to a light-colored substrate, the image is typically placed in direct contact with the substrate and must bond directly thereto. However, in many cases, the bond strength of the ink used to form the image to the substrate is less than optimal to withstand environmental conditions.

### SUMMARY OF THE INVENTION

The present invention provides novel image transfer media, the embodiments of which overcome at least some of the shortcomings identified above in connection with existing image transfer media.

According to one embodiment of the invention and by way of example only, there is provided an image transfer medium, said image transfer medium comprising (a) an image receiving laminate, said image receiving laminate comprising (i) a first release liner; and (ii) an ink-receptive layer for receiving an image, said ink-receptive layer being releasably bonded to said first release liner; and (b) an image protecting laminate, said image protecting laminate comprising (i) a second release liner; and (ii) a first protective layer releasably bonded to said second release liner, said first protective layer being bondable to said ink-receptive layer.

According to another embodiment of the invention, there is provided an image transfer medium, said image transfer medium comprising (a) a release liner; (b) an ink-receptive layer for receiving an image, said ink-receptive layer being releasably bonded to a first area of said release liner; and (c) a protective layer, said protective layer being releasably bonded to a second area of said release liner, said protective layer being bondable to said ink-receptive layer.

The present invention is also directed to methods of using the above-described image transfer media to transfer images to substrates.

For purposes of the present specification and claims, various relational terms like “on,” “over,” “below,” and “under” are used to describe the relative positions of two or more layers of an image transfer medium at one or more stages of image transfer. It is to be understood that, depending upon the particular stage of image transfer and depending upon the type of image transfer medium involved, certain of these relational terms may need to be adjusted accordingly as the arrangement of layers may be inverted after image transfer.

Additional features, advantages and aspects of the present invention and its embodiments are set forth in part in the description which follows, and in part will be obvious from the description or may be learned by practice of the invention. In the description, reference is made to the accompanying drawings which form a part thereof and in which is shown by way of illustration specific embodiments for practicing the invention. These embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate preferred embodiments of the invention and, together with the description, serve to explain the principles of the invention. In the drawings wherein like reference numerals represent like parts:

FIG. 1 is a schematic section view of a conventional image transfer medium of the type that is used to transfer an ink-jet printed image onto a light-colored (i.e., white) substrate;

FIG. 2 is a schematic diagram illustrating the manner in which the image transfer medium of FIG. 1 is used to transfer an image onto a light-colored substrate;

FIG. 3 is a schematic section view of a conventional image transfer medium of the type that is used to transfer an ink-jet printed image onto a dark-colored (i.e., non-white) substrate;

FIG. 4 is a schematic diagram illustrating the manner in which the image transfer medium of FIG. 3 is used to transfer an image onto a dark-colored substrate;

FIG. 5 is a schematic section view of a first embodiment of an image transfer medium constructed according to the teachings of the present invention;

FIGS. 6(a) through 6(e) are schematic diagrams illustrating a first manner in which the image transfer medium of FIG. 5 may be used to transfer an image onto a light-colored substrate;

FIGS. 7(a) through 7(d) are schematic diagrams illustrating a second manner in which the image transfer medium of FIG. 5 may be used to transfer an image onto a light-colored substrate;

FIG. 8 is a schematic section view of a light-colored substrate onto which an image has been transferred using the image transfer medium of FIG. 5, the thermoplastic layer of the image protective laminate being sized sufficiently great to encapsulate the ink-receptive layer and the thermoplastic layer of the image protection laminate;

FIG. 9 is a schematic section view of a first alternate image receiving laminate to the image receiving laminate shown in FIG. 5;

FIG. 10 is a schematic section view of a second alternate image receiving laminate to the image receiving laminate shown in FIG. 5;

FIG. 11 is a schematic section view of a third alternate image receiving laminate to the image receiving laminate shown in FIG. 5;

FIG. 12 is a schematic section view of a second embodiment of an image transfer medium constructed according to the teachings of the present invention;

FIGS. 13(a) through 13(d) are schematic diagrams illustrating the manner in which the image transfer medium of FIG. 12 may be used to transfer an image onto a dark-colored substrate;

FIG. 14 is a schematic section view of a first alternate image receiving laminate to the image receiving laminate shown in FIG. 12;

FIG. 15 is a schematic section view of a second alternate image receiving laminate to the image receiving laminate shown in FIG. 12;

FIG. 16 is a schematic section view of a third alternate image receiving laminate to the image receiving laminate shown in FIG. 12;

FIG. 17 is a schematic section view of a fourth alternate image receiving laminate to the image receiving laminate shown in FIG. 12;

FIG. 18 is a schematic section view of a fifth alternate image receiving laminate to the image receiving laminate shown in FIG. 12;

FIG. 19 is a schematic section view of an alternate image protecting laminate to the image protecting laminate shown in FIG. 12;

FIGS. 20(a) through 20(d) are schematic diagrams illustrating the manner in which the image receiving laminate of FIG. 12 and the image protecting laminate of FIG. 19 may be used to transfer an image onto a dark-colored substrate;

FIG. 21 is a schematic section view of a third embodiment of an image transfer medium constructed according to the teachings of the present invention;

FIGS. 22(a) through 22(g) are schematic diagrams illustrating a first manner in which the image transfer medium of FIG. 21 may be used to transfer an image onto a light-colored substrate;

FIGS. 23(a) and 23(b) are schematic section and bottom views, respectively, of a fourth embodiment of an image transfer medium constructed according to the teachings of the present invention;

FIGS. 24(a) through 24(g) are schematic diagrams illustrating a first manner in which the image transfer medium of FIGS. 23(a) and 23(b) may be used to transfer an image onto a light-colored substrate;

FIGS. 25(a) through 25(g) are schematic diagrams illustrating a second manner in which the image transfer medium of FIGS. 23(a) and 23(b) may be used to transfer an image onto a light-colored substrate;

FIGS. 26(a) and 26(b) are schematic section and top views, respectively, of a fifth embodiment of an image transfer medium constructed according to the teachings of the present invention;

FIGS. 27(a) through 27(g) are schematic diagrams illustrating a manner in which the image transfer medium of FIGS. 26(a) and 26(b) may be used to transfer an image onto a dark-colored substrate;

FIG. 28 is a schematic section view of a sixth embodiment of an image transfer medium constructed according to the teachings of the present invention;

FIGS. 29(a) through 29(d) are schematic diagrams illustrating a manner in which the image transfer medium of FIG. 28 may be used to transfer an image onto a light-colored substrate;

FIG. 30 is a schematic section view of a seventh embodiment of an image transfer medium constructed according to the teachings of the present invention;

FIGS. 31(a) through 31(c) are photographs of the reverse side of (a) a bare fabric, (b) a fabric, prior to washing, to which an image has been transferred using the image transfer medium of FIG. 1, and (c) the fabric of FIG. 31(b) after ten washing cycles; and

FIGS. 32(a) through 32(c) are photographs of the reverse side of (a) a fabric after application of the image protecting laminate thereto, (b) the fabric of FIG. 32(a) after transfer of an image onto the image protecting laminate and prior to washing, and (c) the fabric of FIG. 32(b) after ten washing cycles.

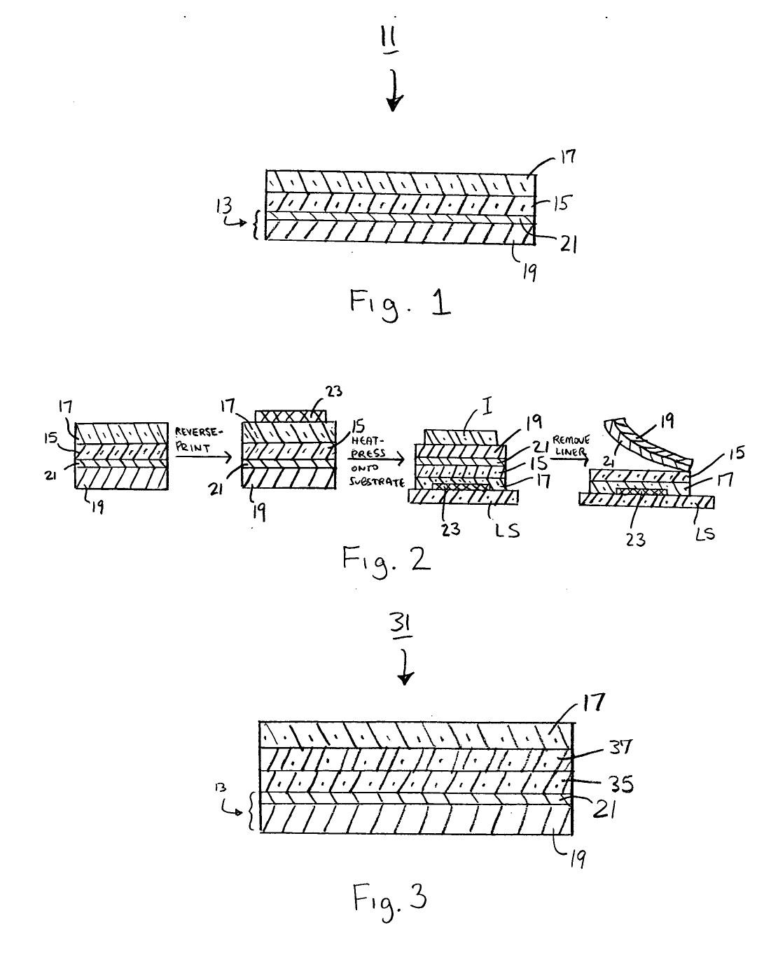

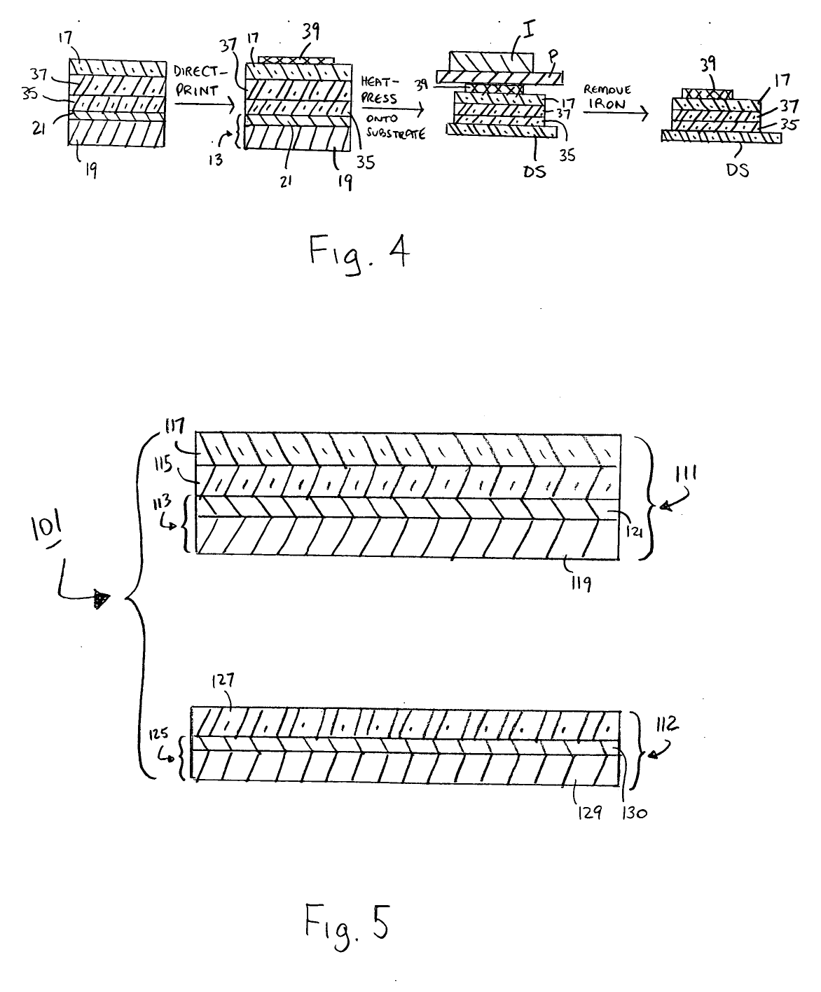

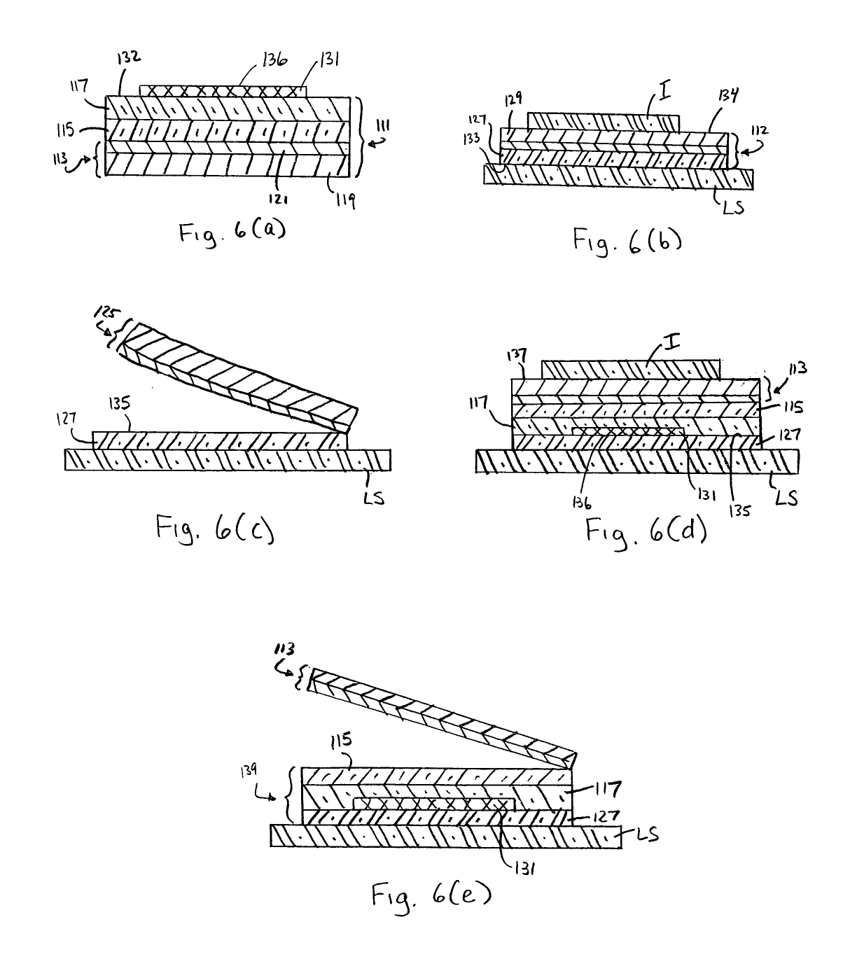

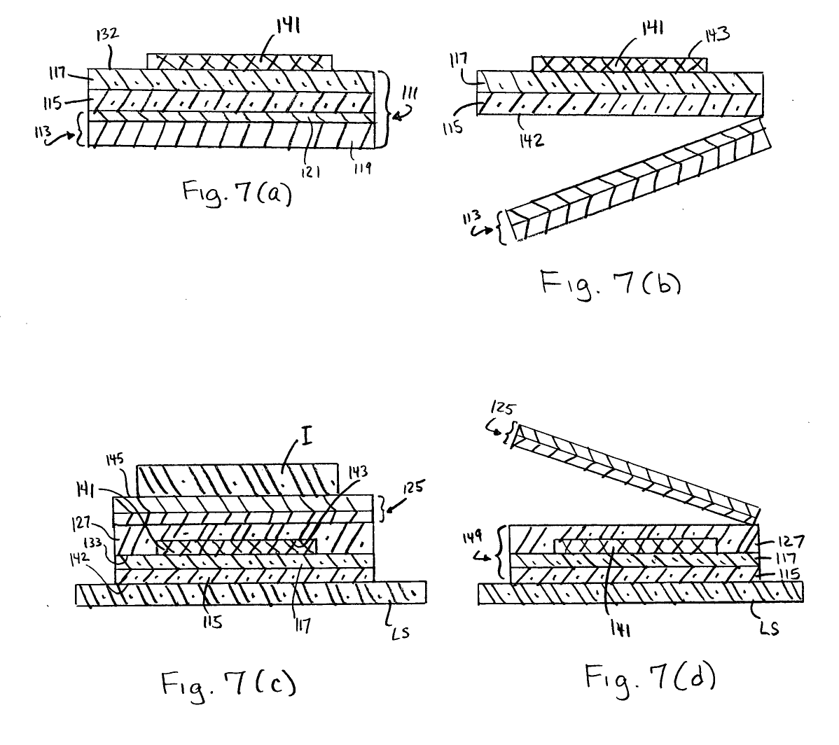

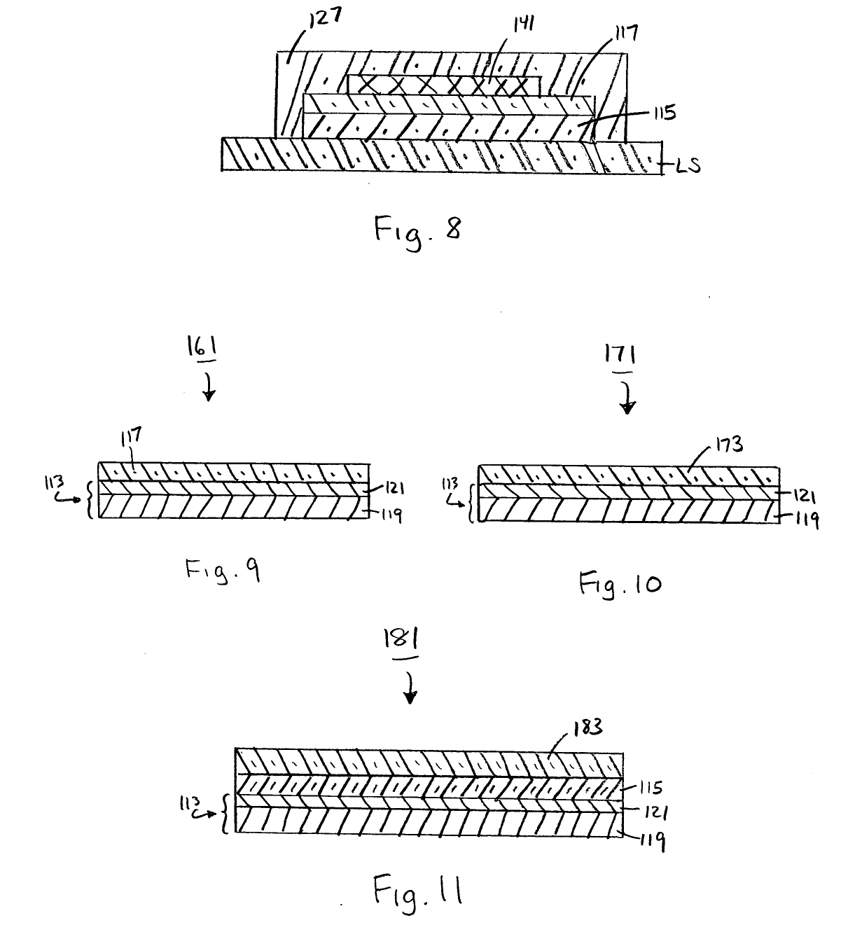

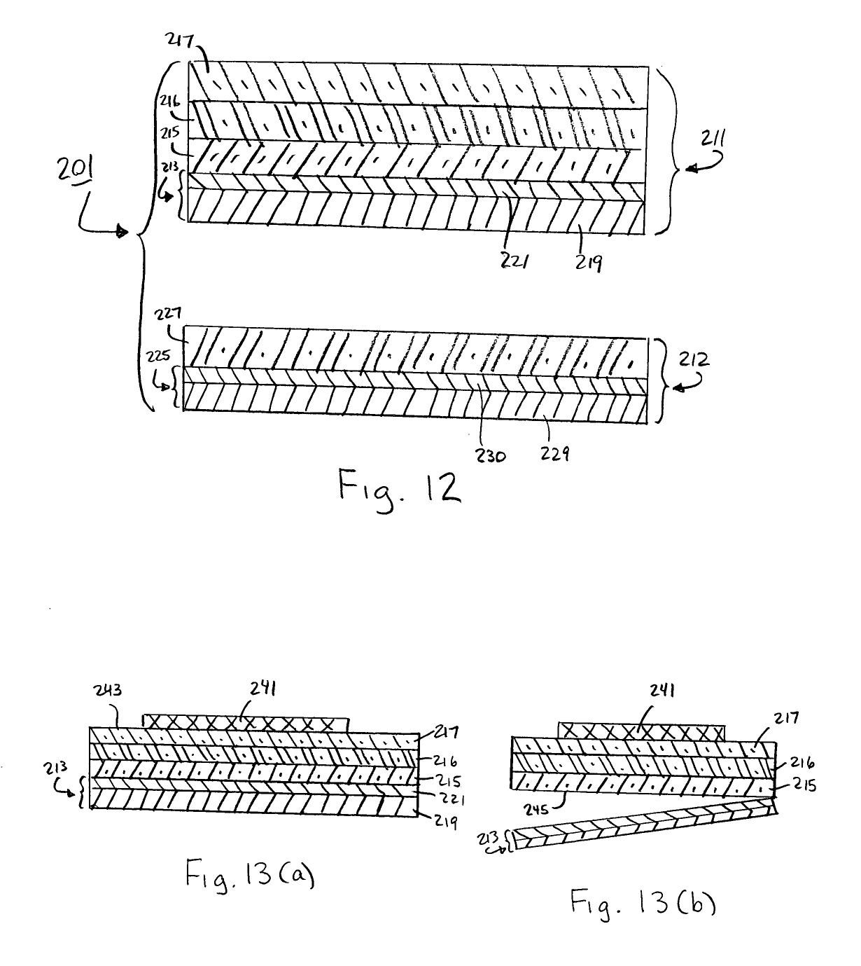

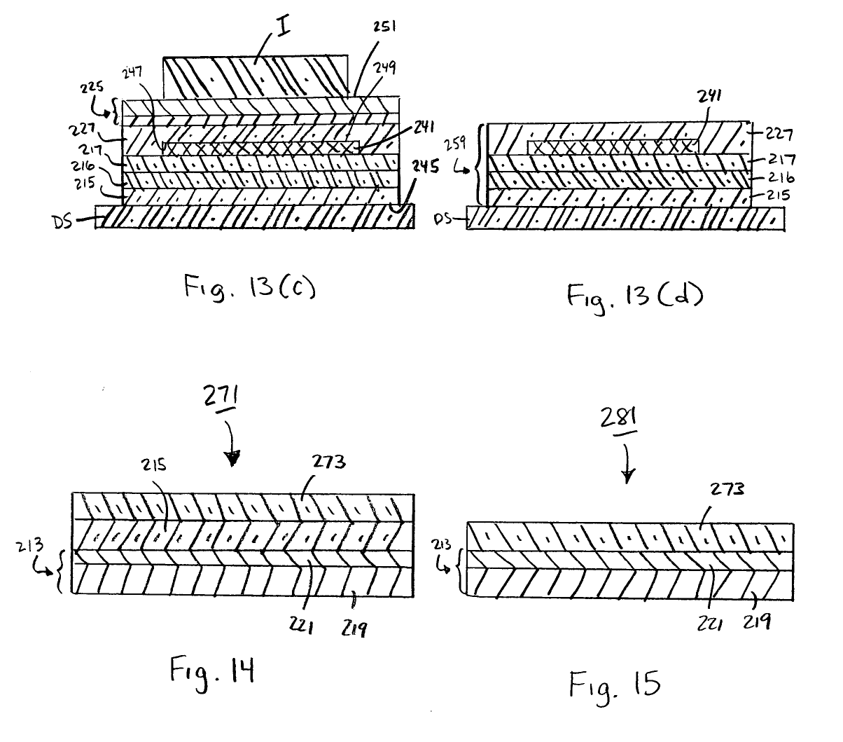

### DETAILED DESCRIPTION OF PREFERRED EMBODIMENTS

Referring now to FIG. 5, there is shown a schematic section view of a first embodiment of an image transfer medium constructed according to the teachings of the present invention, said image transfer medium being represented generally by reference numeral 101.

Image transfer medium 101, which is particularly well-suited for transferring an ink-jet printed image onto a light-colored (i.e., white) substrate, comprises an image receiving laminate 111 and an image protecting laminate 112.

Image receiving laminate 111 comprises a release liner 113, a thermoplastic layer 115 and an ink-receptive layer 117. Release liner 113, in turn, comprises a base 119 and a release coating 121, release coating 121 being coated directly on top of base 119. Base 119 may be a woven or nonwoven material, base 119 preferably having a thickness of about 2 to 10 mils, more preferably about 2 to 6 mils. Preferred materials for use as base 119 include papers, plastic films, and fabrics. Examples of papers suitable for use as base 119 include, but are not limited to, clay-coated papers, resin-coated papers, and latex-impregnated papers. Examples of plastic films suitable for use as base 119 include, but are not limited to, commercially available thermoplastic polymers, such as polyethylene terephthalate and polypropylene, with polyethylene terephthalate being preferred because of its dimensional stability at the high temperatures typically used to dry the layers coated onto base 119.

As explained further below, after image transfer onto a substrate, thermoplastic layer 115 may form the top (i.e., exposed) layer of the transfer laminate. If this is the case and if one wishes the transferred image to have a glossy finish, the top surface of base 119 is preferably made smooth so that the bottom of thermoplastic layer 115 is correspondingly smooth to give a glossy finish. By contrast, if one wishes the transferred image to have a matte finish, the top surface of base 119 is preferably made textured so that the bottom of thermoplastic layer 115 is correspondingly textured to give a matte finish. Although not shown in the present embodiment, the bottom surface of base 119 may be printed with one or more of a trademark, product information, instructions for use and the like.

Release coating 121, which functions to permit release liner 113 to be peeled away from thermoplastic layer 115 at room temperatures, either before or after image transfer, may be a conventional release coating and preferably is a release coating made from a release material including, but not limited to, waxes, silicones, fluorinated polymers and hydrophobic polyesters, with silicones being preferred. Preferably, release coating 121 has a thickness of about 1 to 10 μm, more preferably about 1 to 5 μm. Although not shown in the present embodiment, a primer coating may be applied to the top surface of base 119 prior to the application of release coating 121 onto base 119 in order to improve adhesion and dimensional stability (improved adhesion and dimensional stability being particularly important where base 119 is a paper base).

Thermoplastic layer 115, which is in direct contact with release coating 121, may be a conventional thermoplastic layer for an image transfer medium and preferably comprises at least one thermoplastic polymer preferably having a softening point between 60° C. to 200° C., more preferably between 60° C. to 160° C., and even more preferably between 60° C. to 140° C. Preferably, thermoplastic layer 115 has a thickness of about 0.001 to 10 mils, more preferably about 0.5 to 5 mils, and even more preferably about 0.5 to 3 mils. The thermoplastic polymer may be a cationic polymer and may be hydrophilic or hydrophobic. Unless otherwise specified, a water-insoluble polymer is preferred for uses in which water-resistance and washing-resistance are desirable. Examples of suitable polymers for use in thermoplastic layer 115 include, but are not limited to, polyurethane, polyolefin, polyester, polyamide, ethylene/acrylic acid copolymer, ethylene/methylacrylic acid copolymer, ethylene/vinyl acetate copolymer, crosslinked polyvinyl pyrrolidone (PVP), and polyvinyl chloride. Additional ingredients, such as UV-radiation blocking agents and dye-fixing agents, can be added to thermoplastic layer 115 to improve its resistance to UV radiation and to improve dye-fixation, respectively. In addition, optical brighteners may also be added to thermoplastic layer 115.

As will be explained more fully below, depending upon how image transfer medium 101 is used to transfer an image to a substrate, thermoplastic layer 115 may be oriented so as to be in direct contact with the substrate or so as to form the top layer of the transferred laminate. In those instances in which thermoplastic layer 115 is positioned so as to be in direct contact with the substrate, it serves as an adhesive or anchoring layer to bond the image to the substrate and, therefore, must have sufficient adhesive strength for this purpose. (Where the substrate is a porous material, such as a fabric, thermoplastic layer 115 also serves to prevent color fading by sealing the porous areas of the fabric and to improve cracking resistance of the transferred image.) When used thus as an anchoring layer, thermoplastic layer 115 may be opaque, translucent, or clear. Where the substrate is a fabric, the thermoplastic polymer present in thermoplastic layer 115 preferably has a high melt flowing index so that it can effectively penetrate into the fibers of the fabric for strong bonding without use of excessive pressure.

Alternatively, in those instances in which thermoplastic layer 115 is positioned so as to form the top layer of the transferred laminate, it does not bond the image to the substrate, but rather, serves to protect the image and to impart a soft hand touch to the transferred laminate. When used thus as the top layer of the transferred laminate, thermoplastic layer 115 is preferably clear or becomes sufficiently clear upon transfer so that the underlying image can be seen clearly. In view of the above, if one wishes to have the flexibility to use thermoplastic layer 115 either as an anchoring layer or as the top layer of the transferred laminate, thermoplastic layer 115 is preferably clear.

Ink-receptive layer 117, which is coated directly onto thermoplastic layer 115, may be a conventional ink-receptive layer for ink-jet images. Preferably, ink-receptive layer 117 is an ink-receptive layer of the type comprising a polymeric binder and dispersed polymeric particles held in place by the polymeric binder. In this type of ink-receptive layer, the polymeric particles effectively absorb carriers, such as water and glycol, that are present in the inks, and the interstitial voids formed between the particles receive the inks and encapsulate most of them during thermal transfer. (Such encapsulation of the inks is believed to be very important to achieving washing resistance.) Ink-receptive layer 117 may appear opaque before thermal transfer but preferably becomes transparent after thermal transfer, due to thermal fusion of the polymeric particles. The transparency of ink-receptive layer 117 is particularly important in those instances in which ink-receptive layer 117 is positioned over the image after thermal transfer; on the other hand, in those instances in which ink-receptive layer 117 is positioned under the image after thermal transfer, the transparency of ink-receptive layer 117 is less important. Preferably, ink-receptive layer 117 has a thickness ranging from about 1 to 5 mils, more preferably from about 1 to 3 mils.

The polymeric particles of ink-receptive layer 117 preferably have a particle size ranging from about 5 to 50 μm and surface areas ranging from about 10 to 40 m²/g. Preferably, the polymeric particles constitute from about 5% to 95% of the total weight of the dry coating. Suitable polymeric particles for use in ink-receptive layer 117 include, but are not limited to, polyamide, polyester, and polyolefin particles. Example of particular polyamide particles include Orgasol 3501 EX D NAT and 3502 D NAT made by Atofina (Philadelphia, Pa.) and the Griltex powder series made by EMS Griltech of Switzerland. The polymeric binder for ink-receptive layer 117 may be water-soluble or water-insoluble. Examples of water-soluble polymer binders for use in ink-receptive layer 117 include gelatin, poly(2-ethyl-oxazoline), polyethylene oxide, polypropylene oxide, polyacrylamide, polyvinyl alcohol, polyvinyl acetate, polyvinylpyrrolidone (PVP) and their copolymers or mixtures. Polyethylene oxide preferably has a molecular weight ranging from about 100,000 to 8,000,000 Da. Examples of water-insoluble polymer binders for use in ink-receptive layer 117 include polyesters, ethylene/acrylic acid copolymer, ethylene/methylacrylic acid copolymer, ethylene/vinyl acetate copolymer, crosslinked PVP, and their mixtures. Preferably, the polymeric binder constitutes about 5% to 95% of the total weight of the dry coating. Other components, such as surfactants and viscosity modifiers, can be added to ink-receptive layer 117. An example of a suitable surfactant is Zonyl FSA wetting agent (E.I. DuPont, Wilmington, Del.). An example of a suitable viscosity modifier is Tafigel PUR 61 thickener (Ultra Additives, Bloomfield, N.J.). As can be appreciated, ink-receptive layer 117 must be sufficiently compatible with thermoplastic layer 115 to permit ink-receptive layer 117 to be properly coated onto thermoplastic layer 115.

Image protecting laminate 112 comprises a release liner 125 and a thermoplastic layer 127. Release liner 125, which may be identical to release liner 113, includes a base 129 and a release coating 130, base 129 and coating 130 optionally being identical to base 119 and coating 121, respectively.

Thermoplastic layer 127, which is in direct contact with release coating 130, preferably comprises at least one water-insoluble thermoplastic polymer preferably having a softening point between 60° C. to 200° C., more preferably between 60° C. to 150° C., and even more preferably between 60° C. to 140° C. Preferably, thermoplastic layer 127 has a thickness of about 0.0001 to 10 mils, more preferably about 1 to 6 mils, and even more preferably about 1 to 3 mils. The thermoplastic polymer may be a cationic polymer and may additionally include ingredients, such as UV-radiation blocking agents and dye-fixing agents, such as quaternary amines and ammonium salts. Examples of suitable thermoplastic polymers for use in thermoplastic layer 127 include, but are not limited to, polyurethane, polyamide, polyester, polyvinyl chloride, ethylene/acrylic acid copolymer, ethylene/methacrylic acid copolymer, ethylene/vinyl acetate copolymer and any other polymer or combination of polymers that can be laminated onto ink-receptive layer 117 in the manner to be described below. Thermoplastic layer 127 may be made by hot-melt extrusion or by coating from water or solvent dispersions.

As will be explained more fully below, depending upon how image transfer medium 101 is used to transfer an image to a substrate, thermoplastic layer 127 may be oriented so as to be in direct contact with the substrate or so as to form the top layer of the transferred laminate. In those instances in which thermoplastic layer 127 is positioned so as to be in direct contact with the substrate, it serves as an adhesive or anchoring layer to bond the image to the substrate and, therefore, must have sufficient adhesive strength for this purpose. (Where the substrate is a porous material, such as a fabric, thermoplastic layer 127 also serves to prevent color fading by sealing the porous areas of the fabric and to improve cracking resistance of the transferred image.) For such use as an anchorage layer, thermoplastic layer 127 may be opaque, translucent, or clear. Where the substrate is a fabric, the thermoplastic polymer present in thermoplastic layer 127 preferably has a high melt flowing index so that it can effectively penetrate into the fibers of the fabric for strong bonding.

In those instances in which thermoplastic layer 127 is positioned so as to form the top layer of the transferred laminate, it does not bond the image to the substrate, but rather, serves to protect the image and to impart a soft hand touch to the transferred laminate. For such use as a top layer, thermoplastic layer 127 is preferably clear or becomes clear upon transfer so that the underlying image can be seen clearly. In view of the above, if one wishes to have the flexibility to use thermoplastic layer 127 either as an anchoring layer or as the top layer of the transferred laminate, thermoplastic layer 127 is preferably clear or becomes clear upon transfer. However, it should be understood that, even when used as the top layer of the transferred laminate, thermoplastic layer 127 need not always be clear; rather, thermoplastic layer 127 could additionally include one or more pigments designed to give the image a desired optical effect (e.g., thermochromic pigments, pigments that change color in response to water exposure, pigments that give the image a hazy or frosted appearance, etc.).

Referring now to FIGS. 6(a) through 6(e), there is shown a series of schematic section views, illustrating one way in which image transfer medium 101 may be used to transfer an image, such as an ink-jet printed image, onto a light-colored (i.e., white) substrate LS, such as a white T-shirt. First, as seen in FIG. 6(a), an image 131 is reverse-printed, preferably using an ink-jet printer, onto a surface 132 of ink-receptive layer 117. Although not shown, image receiving laminate 111 may then be cut to a size matching or slightly greater than image 131, and image protecting laminate 112 may be cut to a size matching or slightly greater than image receiving laminate 111. Next, as seen in FIG. 6(b), a surface 133 of thermoplastic layer 127 of image protecting laminate 112 is placed in contact with light-colored substrate LS, and a heat press or household iron I is pressed against a surface 134 of release liner base 129 until sufficient heat and pressure are transmitted through release liner 125 to thermoplastic layer 127 to cause thermoplastic layer 127 to bond to light-colored substrate LS. Next, as seen in FIG. 6(c), release liner 125 is peeled away from thermoplastic layer 127, thereby exposing a surface 135 of thermoplastic layer 127. Next, as seen in FIG. 6(d), a surface 136 of image 131 is placed on top of surface 135 of thermoplastic layer 127, and heat press or household iron I is pressed against a surface 137 of release liner 113 until sufficient heat and pressure are transmitted to ink-receptive layer 117 (e.g., about 15 to 30 seconds at a temperature of about 140° C.) to cause ink-receptive layer 117 and image 131 to bond to thermoplastic layer 127, thereby sandwiching image 131 between ink-receptive layer 117 and thermoplastic layer 127. Finally, as seen in FIG. 6(e), iron I is removed and release liner 113 is peeled away from thermoplastic layer 115, leaving a transferred laminate 139 on light-colored substrate LS.

It should be understood that, instead of bonding thermoplastic layer 127 to light-colored substrate LS and then bonding ink-receptive layer 117 and image 131 to thermoplastic layer 127, one could bond ink-receptive layer 117 and image 131 to thermoplastic layer 127 and then bond thermoplastic layer 127 to light-colored substrate LS or could bond ink-receptive layer 117 and image 131 to thermoplastic layer 127 at the same time thermoplastic layer 127 is bonded to light-colored substrate LS. Where ink-receptive layer 117 and image 131 are bonded to thermoplastic layer 127 prior to bonding thermoplastic layer 127 to light-colored substrate LS, release liner 113 preferably has a higher release value from thermoplastic layer 115 than release liner 125 has from thermoplastic layer 127.

It should also be noted that, although iron I is shown in the present embodiment (and elsewhere in the present specification) heating various layers from the top, the application of heat and pressure may also be applied to such layers from the bottom, i.e., by positioning iron I directly against light-colored substrate LS, as the direction of heating and pressure is inconsequential in many instances and is simply a matter of convenience.

Referring now to FIGS. 7(a) through 7(d), there is shown a series of schematic section views, illustrating another way in which image transfer medium 101 may be used to transfer an image, such as an ink-jet printed image, onto a light-colored (i.e., white) substrate LS, such as a white T-shirt. First, as seen in FIG. 7(a), an image 141 is direct-printed, preferably using an ink-jet printer, onto surface 132 of ink-receptive layer 117. Although not shown, image receiving laminate 111 may then be cut to a size matching or slightly greater than image 141, and image protecting laminate 112 may be cut to a size matching or slightly greater than image receiving laminate 111. Next, as seen in FIG. 7(b), release liner 113 is peeled away from thermoplastic layer 115, thereby exposing a surface 142 of thermoplastic layer 115. Next, as seen in FIG. 7(c), with surface 142 of thermoplastic layer 115 placed directly on top of light-colored substrate LS and with surface 133 of thermoplastic layer 127 placed directly on top of a surface 143 of image 141, heat press or household iron I is pressed against a surface 145 of release liner 125 until sufficient heat and pressure are transmitted to thermoplastic layer 127 and to thermoplastic layer 115 (e.g., about 15 to 30 seconds at a temperature of about 140° C.) to cause thermoplastic layer 127 to bond to image 141 and to ink-receptive layer 117 and to cause thermoplastic layer 115 to bond to light-colored substrate LS. Finally, as seen in FIG. 7(d), release liner 125 is peeled away from thermoplastic layer 127, leaving a transferred laminate 149 on light-colored substrate LS.

It should be understood that, instead of bonding thermoplastic layer 127 to image 141 and to ink-receptive layer 117 and, at the same time, bonding thermoplastic layer 115 to light-colored substrate LS, one could first bond thermoplastic layer 127 to image 141 and to ink-receptive layer 117 and then could bond thermoplastic layer 115 to light-colored substrate LS. Where thermoplastic layer 127 is bonded to image 141 and to ink-receptive layer 117 prior to bonding thermoplastic layer 115 to light-colored substrate LS, release liner 125 preferably has a higher release value from thermoplastic layer 127 than release liner 113 has from thermoplastic layer 115.

It should also be understood that, if one were to size thermoplastic layer 127 sufficiently large relative to ink-receptive layer 117 and thermoplastic layer 115 so that the peripheral edges of thermoplastic layer 127 bonded directly to light-colored substrate LS, thereby encapsulating ink-receptive layer 117, thermoplastic layer 115 and printed image 141 (see FIG. 8), ink-receptive layer 117 could alternatively be made of an ink-receptive material of the type comprising a cationic polymer, such as that disclosed in U.S. Pat. No. 6,153,288, inventors Shih et al., which issued Nov. 28, 2000, and which is incorporated herein by reference. In fact, where ink-receptive layer 117 is encapsulated in the manner described above, ink-receptive layer 117 may be made of a water-soluble polymer.

It should additionally be noted that, although image transfer medium 101 has been described herein as being used to transfer a printed image onto a light-colored (i.e., white) substrate, image transfer medium 101 could be used in some cases, depending upon the color of the printed image and the color of the substrate, to transfer a printed image onto a non-white substrate.

As can be seen by comparing FIGS. 6(e) and 7(d) to FIG. 2, one advantage of using image transfer medium 101, instead of image transfer medium 11, to transfer an ink-jet printed image onto a light-colored T-shirt or similar substrate, is that the use of image transfer medium 101 results in a transferred laminate in which the printed image is sandwiched between ink-receptive layer 117 and thermoplastic layer 127, instead of the printed image being left exposed on either its top surface or its bottom surface to environmental attack (e.g., water degradation during washing).

Another advantage to using image transfer medium 101, instead of image transfer 11, to transfer an ink-jet printed image onto a light-colored T-shirt or similar substrate, is that the use of image transfer medium 101 results in a transferred laminate in which either thermoplastic layer 115 or thermoplastic layer 127 is used to bond the transferred laminate to the substrate, instead of the printed image bonding directly to the substrate. As can readily be appreciated, the bonding strength of thermoplastic layers 115 and 127 is preferably substantially greater than that of the printed image.

Still another advantage to using image transfer medium 101, instead of image transfer 11, to transfer an ink-jet printed image onto a light-colored T-shirt or similar substrate, is that image transfer medium 101 affords one the flexibility of either reverse-printing the image onto ink-receptive layer 117 or direct-printing the image onto ink-receptive layer 117.

Referring now to FIG. 9, there is shown a schematic section view of a first alternate image receiving laminate to image receiving laminate 111, said first alternate image receiving laminate being represented generally by reference numeral 161.

Image receiving laminate 161 is similar in many respects to image receiving laminate 111, the principal difference between the two image receiving laminates being that image receiving laminate 161 does not include a layer corresponding to thermoplastic layer 1115. Consequently, in image receiving laminate 161, ink-receptive layer 117 is positioned directly on top of release coating 121 of release liner 113. Because image receiving laminate 161 does not include a thermoplastic layer, in those instances in which image receiving laminate 161 is used analogously to the process shown in FIGS. 7(a) through 7(d), i.e., so that ink-receptive layer 117 is bonded directly to the light-colored substrate, ink-receptive layer 117 should be formulated to possess sufficient bond-strength to bond directly to the light-colored substrate.

Image receiving laminate 161 may be used analogously to image receiving laminate 111 to transfer either a direct-printed image or a reverse-printed image onto a light-colored substrate.

Referring now to FIG. 10, there is shown a schematic section view of a second alternate image receiving laminate to image receiving laminate 111, said second alternate image receiving laminate being represented generally by reference numeral 171.

Image receiving laminate 171 is similar in many respects to image receiving laminate 161, the principal difference between the two image receiving laminates being that image receiving laminate 171 includes an ink-receptive layer 173, instead of ink-receptive layer 117, ink-receptive layer 173 being positioned directly on top of release coating 121 of release liner 113. Ink-receptive layer 173 differs from ink-receptive layer 117 in that ink-receptive layer 173 additionally includes “glow-in-the-dark” pigments, i.e., pigments that absorb light during the day or under irradiation and slowly emit phosphorescence at night or under dark conditions. Examples of suitable glow-in-the-dark pigments include commercially available materials, such as zinc sulfide, alkaline earth aluminates, alkaline earth silicates. Preferably, the glow-in-the-dark pigment is water-insoluble and has a clear or white daytime color, with clear being preferred if one wishes to have the flexibility to reverse-print onto ink-receptive layer 173. Ink-receptive layer 173 preferably has a thickness of about 20 μm to 100 μm.

It should be understood that, instead of including glow-in-the-dark pigments in ink-receptive layer 173, one could include other types of pigments in ink-receptive layer 173, such as thermochromic pigments for causing the image to change color when subjected to heat and/or fluorescent pigments, such as those pigments capable of emitting light when illuminated with UV light, such as “black light.” Alternatively, one could include a combination of water-soluble and water-insoluble pigments in ink-receptive layer 173 so that the image changes color upon washing. For example, if a water-soluble blue pigment and a water-insoluble yellow pigment were dispersed in ink-receptive layer 173, ink-receptive layer 173 would experience a change, upon washing, from green (due to the presence of yellow and blue) to yellow (due to the presence of yellow alone).

Image receiving laminate 171 may be used analogously to image receiving laminate 111 to transfer either a direct-printed image or a reverse-printed image onto a light-colored substrate.

Referring now to FIG. 11, there is shown a schematic section view of a third alternate image receiving laminate to image receiving laminate 111, said third alternate image receiving laminate being represented generally by reference numeral 181.

Image receiving laminate 181 is similar in many respects to image receiving laminate 111, the principal difference between the two image receiving laminates being that image receiving laminate 181 includes, instead of ink-receptive layer 117, an alternative ink-receptive layer 183 (e.g., glow-in-the-dark, thermochromic, fluorescent, color-changing) that is identical to ink-receptive layer 173.

Image receiving laminate 181 may be used analogously to image receiving laminate 111 to transfer either a direct-printed image or a reverse-printed image onto a light-colored substrate.

Referring now to FIG. 12, there is shown a schematic section view of a second embodiment of an image transfer medium constructed according to the teachings of the present invention, said image transfer medium being represented generally by reference numeral 201.

Image transfer medium 201, which is particularly well-suited for transferring an ink-jet printed image onto a dark-colored (i.e., non-white) substrate, comprises an image receiving laminate 211 and an image protecting laminate 212.

Image receiving laminate 211 comprises a release liner 213, a thermoplastic layer 215, a white layer 216 and an ink-receptive layer 217. Release liner 213, which is preferably identical to release liner 113, comprises a base 219 and a release coating 221, release coating 221 being coated directly on top of base 219. Base 219 is preferably identical to base 119, and release coating 221 is preferably identical to release coating 121. Thermoplastic layer 215, which is preferably identical to thermoplastic layer 15, is in direct contact with the top of release coating 221. White layer 216, which is deposited directly on top of thermoplastic layer 215, may comprise a white inorganic pigment and a polymeric binder. Examples of suitable white inorganic pigments for use in making white layer 216 include, but are not limited to, conventional white pigments, such as titanium dioxide, silicon dioxide, alumina, and zinc oxide. Of the aforementioned white inorganic pigments, titanium dioxide is preferred because it can be obtained in the form of a water dispersion. The polymeric binder used to make white layer 216 may be water-soluble or water-insoluble. Examples of suitable polymeric binders include polyamides, polyurethanes, polyethylene oxide, polyacrylic acid, polyvinyl acetate, polyesters, polyolefins, polyvinyl chloride, polystyrene, polymethacrylic acid, and their mixtures or copolymers. Preferably, the white inorganic pigment constitutes about 5% to 50% of the total coating weight, and the polymer binder constitutes about 50% to 95% of the total coating weight.

Alternatively, instead of including a white inorganic pigment in white layer 216, white layer 216 may be made by a process wherein light-scattering voids are introduced into the layer to give the layer a white appearance. Examples of such processes include cavitation or, in the case of extremely small voids, micro-cavitation. Cavitation in film layers can be effected through a variety of techniques. According to one technique, incompatible materials, in which one is a minor component, phase-separate, forming domains. These domains, themselves, may impart the white color, or if the thermal expansion is sufficiently dissimilar, voids may form as the domains cool. A second technique involves physical manipulation. More specifically, once a film is formed, it is drawn or stretched. Depending on the material or various additives, cavitation occurs. A third technique is to add blowing agents to a film as it is produced. Typically, these blowing agents are chemicals which are added to an extruder and are blended with the molten polymer. As the temperature of the mixture is raised beyond a certain point, the blowing agent decomposes, forming a gas. The gas produces very small bubbles in the film. Examples of typical blowing agents include, but not limited to, ammonium or sodium bicarbonate, azodicarbonamide and oxybis(benzenesulphonylhydrazide).

White layer 216 preferably has a thickness of about 20 to 200 μm, more preferably 20 to 100 μm, even more preferably 20 to 75 μm. Ink receptive layer 217, which is deposited directly on top of white layer 216, is preferably identical to ink-receptive layer 117.

Image protecting laminate 212 comprises a release liner 225 and a thermoplastic layer 227. Release liner 225, which is preferably identical to release liner 125, includes a base 229 and a release coating 230, release coating 230 being coated directly on top of base 229. Base 229 and coating 230 are preferably identical to base 129 and release coating 130, respectively. Thermoplastic layer 227, which is deposited directly on top of release coating 230, is preferably identical to thermoplastic layer 127.

Referring now to FIGS. 13(a) through 13(d), there is shown a series of schematic section views, illustrating a way in which image transfer medium 201 may be used to transfer an image, such as an ink-jet printed image, onto a dark-colored (i.e., non-white) substrate DS, such as a non-white (e.g., gray, navy) T-shirt. First, as seen in FIG. 13(a), an image 241 is direct-printed, preferably using an ink-jet printer, onto a surface 243 of ink-receptive layer 217. Although not shown, image receiving laminate 211 may then be cut to a size matching or slightly greater than image 241, and image protecting laminate 212 may be cut to a size matching or slightly greater than image receiving laminate 211. Next, as seen in FIG. 13(b), release liner 213 is peeled away from thermoplastic layer 215, thereby exposing a surface 245 of thermoplastic layer 215. Next, as seen in FIG. 13(c), with surface 245 of thermoplastic layer 215 placed directly on top of dark-colored substrate DS and with a surface 247 of thermoplastic layer 227 placed directly on top of a surface 249 of image 241, heat press or household iron I is pressed against a surface 251 of release liner 225 until sufficient heat and pressure are transmitted to thermoplastic layer 227 and to thermoplastic layer 215 (e.g., about 15 to 30 seconds at a temperature of about 140° C.) to cause thermoplastic layer 227 to bond to image 241 and to ink-receptive layer 217 and to cause thermoplastic layer 215 to bond to dark-colored substrate DS. Finally, as seen in FIG. 13(d), release liner 225 is peeled away from thermoplastic layer 227, leaving a transferred laminate 259 on dark-colored substrate DS.

It should be understood that, instead of bonding thermoplastic layer 227 to image 241 and to ink-receptive layer 217 and, at the same time, bonding thermoplastic layer 215 to dark-colored substrate DS, one could first bond thermoplastic layer 227 to image 241 and to ink-receptive layer 217 and then could bond thermoplastic layer 215 to dark-colored substrate DS. Where thermoplastic layer 227 is bonded to image 241 and to ink-receptive layer 217 prior to bonding thermoplastic layer 215 to dark-colored substrate DS, release liner 225 preferably has a higher release value from thermoplastic layer 227 than release liner 213 has from thermoplastic layer 215.

It should be noted that, although image transfer medium 201 has been described herein as being used to transfer a printed image onto a dark-colored (i.e., non-white) substrate, image transfer medium 201 could alternatively be used to transfer a printed image onto a light-colored (i.e., white) substrate.

Referring now to FIG. 14, there is shown a schematic section view of a first alternate image receiving laminate to image receiving laminate 211, said first alternate image receiving laminate being represented generally by reference numeral 271.

Image receiving laminate 271 is similar in many respects to image receiving laminate 211, the principal difference between the two image receiving laminates being that, instead of having white layer 216 and ink-receptive layer 217, image receiving laminate 271 has an ink-receptive layer 273, ink-receptive layer 273 being similar to ink-receptive layer 217 but additionally including a suitable amount of a white inorganic pigment of the type present in white layer 216 to provide image contrast.

Image receiving laminate 271 may be used analogously to image receiving laminate 211 to transfer a printed image onto a substrate.

Referring now to FIG. 15, there is shown a schematic section view of a second alternate image receiving laminate to image receiving laminate 211, said second alternate image receiving laminate being represented generally by reference numeral 281.

Image receiving laminate 281 is similar in many respects to image receiving laminate 271, the principal difference between the two image receiving laminates being that image receiving laminate 281 does not include a layer corresponding to thermoplastic layer 215. Consequently, in image receiving laminate 281, ink-receptive layer 273 is positioned directly on top of release coating 221 of release liner 213. Because image receiving laminate 281 does not include a thermoplastic layer and because ink-receptive layer 273 is bonded directly to the substrate, ink-receptive layer 273 is preferably formulated to possess sufficient bond-strength to bond directly and securely to the substrate.

Image receiving laminate 281 may be used analogously to image receiving laminate 211 to transfer a printed image onto a substrate.

Referring now to FIG. 16, there is shown a schematic section view of a third alternate image receiving laminate to image receiving laminate 211, said third alternate image receiving laminate being represented generally by reference numeral 291.

Image receiving laminate 291 is similar in many respects to image receiving laminate 211, the principal difference between the two image receiving laminates being that image receiving laminate 291 includes, instead of ink-receptive layer 217, an alternative ink-receptive layer 293 (e.g., glow-in-the-dark, thermochromic, fluorescent, color-changing) that is identical to ink-receptive layer 173.

Image receiving laminate 291 may be used analogously to image receiving laminate 211 to transfer a printed image onto a substrate.

Referring now to FIG. 17, there is shown a schematic section view of a fourth alternate image receiving laminate to image receiving laminate 211, said fourth alternate image receiving laminate being represented generally by reference numeral 301.

Image receiving laminate 301 is similar in many respects to image receiving laminate 211, the principal difference between the two image receiving laminates being that image receiving laminate 301 does not include a layer corresponding to thermoplastic layer 215. Consequently, in image receiving laminate 301, white layer 216 is positioned directly on top of release coating 221 of release liner 213. Because image receiving laminate 301 does not include a thermoplastic layer and because white layer 216 is bonded directly to the substrate, white layer 216 is preferably formulated to possess sufficient bond-strength to bond directly and securely to the substrate.

Image receiving laminate 301 may be used analogously to image receiving laminate 211 to transfer a printed image onto a substrate.

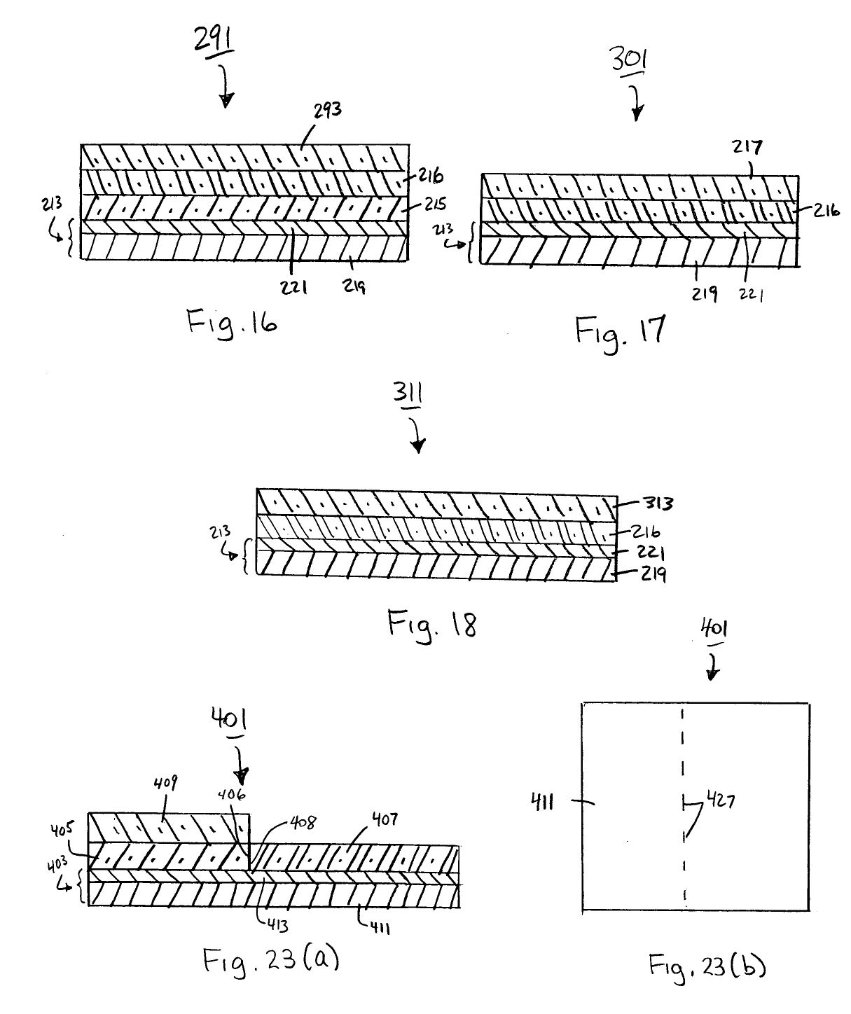

Referring now to FIG. 18, there is shown a schematic section view of a fifth alternate image receiving laminate to image receiving laminate 211, said fifth alternate image receiving laminate being represented generally by reference numeral 311.

Image receiving laminate 311 is similar in many respects to image receiving laminate 301, the principal difference between the two image receiving laminates being that image receiving laminate 311 includes, instead of ink-receptive layer 217, an alternative ink-receptive layer 313 (e.g., glow-in-the-dark, thermochromic, fluorescent, color-changing) that is identical to ink-receptive layer 173.

Image receiving laminate 311 may be used analogously to image receiving laminate 211 to transfer a printed image onto a substrate.

Referring now to FIG. 19, there is shown a schematic section view of an alternate image protecting laminate to image protecting laminate 212, said alternate image protecting laminate being represented generally by reference numeral 351.

Image protecting laminate 351 is similar in many respects to image protecting laminate 212, the principal difference between the two image protecting laminates being that image protecting laminate 351 includes, instead of thermoplastic layer 227, an alternative thermoplastic layer 353. Thermoplastic layer 353 differs notably from thermoplastic layer 227 in that, when heated, thermoplastic layer 353 selectively bonds to ink-receptive layer 217 of image receiving laminate 211 and does not bond to the substrate. Consequently, as contrasted with image protecting laminate 212, which is preferably cut, prior to being placed over image receiving laminate 211, to a size matching or slightly greater than image receiving laminate 211, image protecting laminate 351 need not be similarly cut prior to being placed over image receiving laminate 211 as only the portion of thermoplastic layer 353 in contact with image receiving laminate 211 transfers. As can readily be appreciated, this elimination of the cutting step can save the user a considerable amount of time, especially where image receiving laminate 211 has a small and/or irregular shape. Moreover, because image protecting laminate 351 need not match or substantially match image receiving laminate 211 prior to being placed over image receiving laminate 211, but rather, may cover an area much greater than image receiving laminate 211, the alignment of image protecting laminate 351 and image receiving laminate 211 is substantially facilitated. Furthermore, because image protecting laminate 351 may cover an area considerably greater than image receiving laminate 211, there is minimal risk that image protecting laminate 351 will be displaced from its position on top of image receiving laminate 211 by the moving back and forth of a household iron across image protecting laminate 351. As can be appreciated, if the image protecting laminate is displaced from image receiving laminate 211 by a household iron, the household iron may come into direct contact with the printed image, thereby causing damage to the printed image.

Thermoplastic layer 353 may be made, for example, from a composition comprising 5 g of 1% POLYOX® 301 polyethylene oxide solution in deionized water (Dow Chemical), 0.1 g Tafigel Pur 61 thickener (Ultra Additives), 3 g of GEON® 213 PVC particles (PolyOne), 2 g of Witcobond-213 cationic urethane polymer dispersion (Crompton, N.J.) and 0.5 g of a 1:1 weight ratio mixture of benzyl butyl phthalate (Aldrich) and dioctyl phthalate (Eastman Chemical) plasticizers. In an alternative composition, the amount of the 1:1 benzyl butyl phthalate/dioctyl phthalate mixture is increased to 2.0 g, and a crosslinking agent in the form of Bacoate 20 crosslinking agent (Magnesium Elektron, Inc.) is added. Surfactants and defoamers may be added to each of the above formulations to improve their wetting properties. Moreover, ammonia concentrate may be added to each of the above formulations to adjust pH.

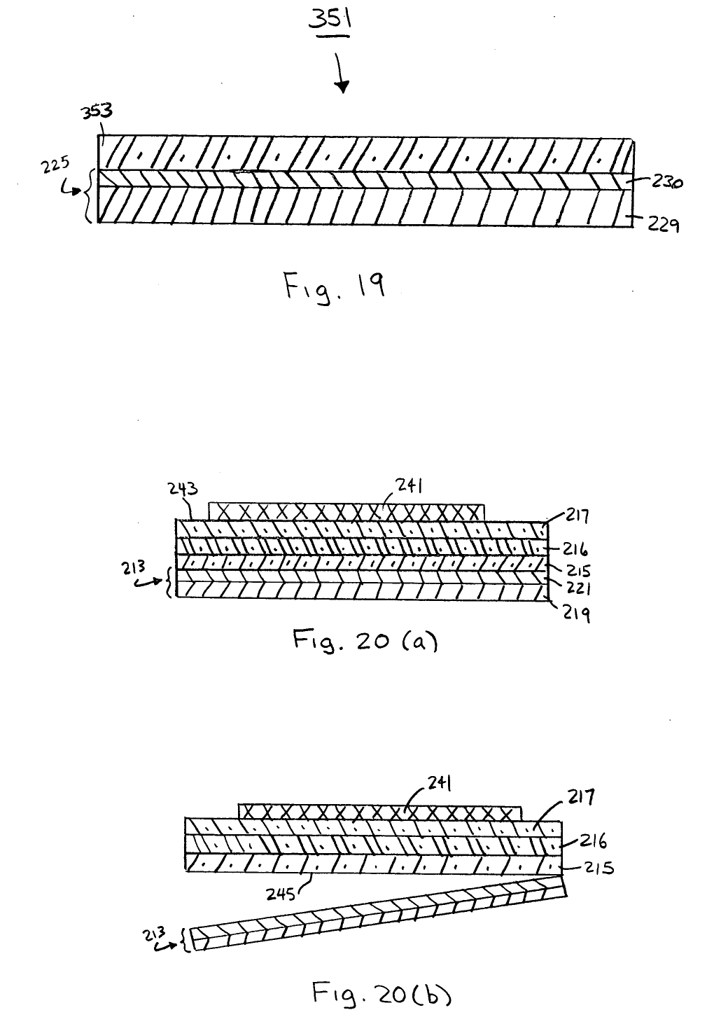

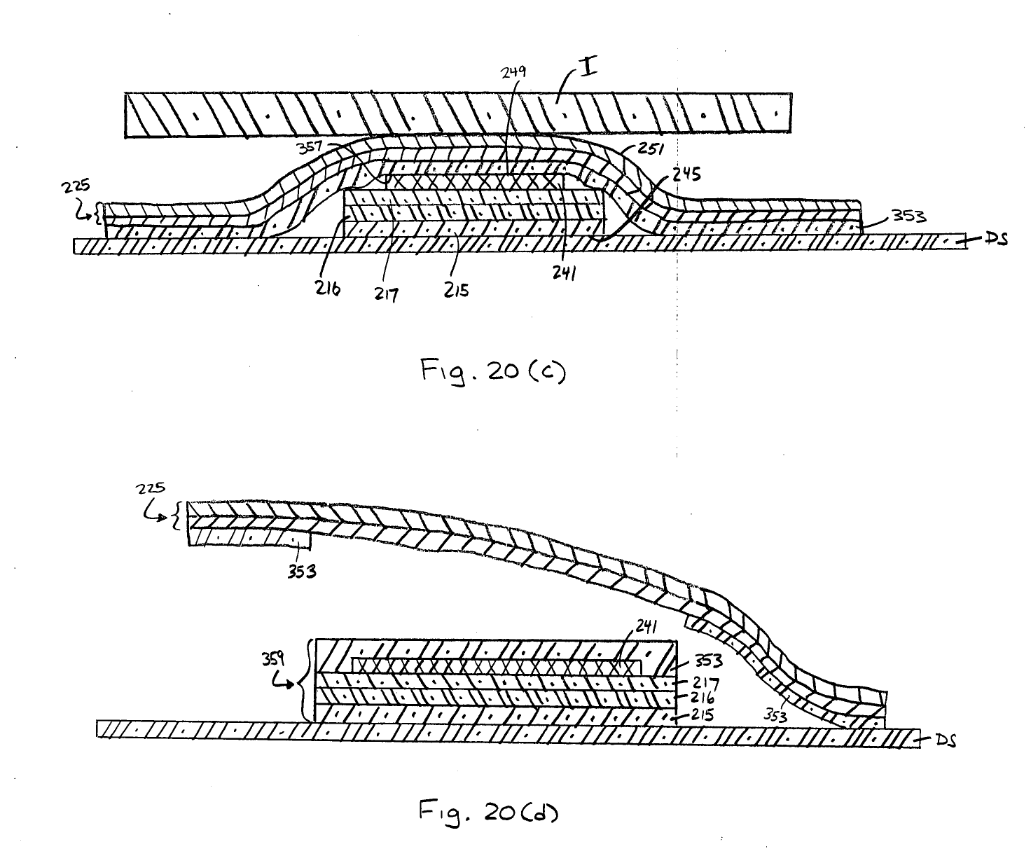

Referring now to FIGS. 20(a) through 20(d), there is shown a series of schematic section views, illustrating a way in which image receiving laminate 211 and image protecting laminate 351 may be used to transfer an image, such as an ink-jet printed image, onto a dark-colored (i.e., non-white) substrate DS, such as a non-white (e.g., gray, navy) T-shirt. First, as seen in FIG. 20(a), an image 241 is direct-printed, preferably using an ink-jet printer, onto a surface 243 of ink-receptive layer 217. Although not shown, image receiving laminate 211 may then be cut to a size matching or slightly greater than image 241. Next, as seen in FIG. 20(b), release liner 213 is peeled away from thermoplastic layer 215, thereby exposing a surface 245 of thermoplastic layer 215. Next, as seen in FIG. 20(c), with surface 245 of thermoplastic layer 215 placed directly on top of dark-colored substrate DS and with a surface 357 of thermoplastic layer 353 placed directly on top of a surface 249 of image 241, heat press or household iron I is pressed against a surface 251 of release liner 225 until sufficient heat and pressure are transmitted to thermoplastic layer 353 and to thermoplastic layer 215 (e.g., about 15 to 30 seconds at a temperature of about 140° C.) to cause thermoplastic layer 353 to bond to image 241 and to ink-receptive layer 217 and to cause thermoplastic layer 215 to bond to dark-colored substrate DS. Finally, as seen in FIG. 20(d), after allowing the transfer to cool, release liner 225 is peeled away from that part of thermoplastic layer 353 in contact with ink-receptive layer 217 and printed image 241, leaving a transferred laminate 359 on dark-colored substrate DS.

It should be understood that, instead of bonding thermoplastic layer 353 to image 241 and to ink-receptive layer 217 and, at the same time, bonding thermoplastic layer 215 to dark-colored substrate DS, one could first bond thermoplastic layer 353 to image 241 and to ink-receptive layer 217 and then could bond thermoplastic layer 215 to dark-colored substrate DS. Where thermoplastic layer 353 is bonded to image 241 and to ink-receptive layer 217 prior to bonding thermoplastic layer 215 to dark-colored substrate DS, release liner 225 preferably has a higher release value from thermoplastic layer 353 than release liner 213 has from thermoplastic layer 215.

In addition, it should be noted that, although image receiving laminate 211 and image protecting laminate 351 have been described herein as being used to transfer a printed image onto a dark-colored (i.e., non-white) substrate, image receiving laminate 211 and image protecting laminate 351 could alternatively be used to transfer a printed image onto a light-colored (i.e., white) substrate.

Moreover, it should be noted that, although image protecting laminate 351 has been described herein as being used with image receiving laminate 211, image protecting laminate is not limited to use therewith and may also be used with any of the other image receiving laminates described above.

Referring now to FIG. 21, there is shown a schematic section view of a third embodiment of an image transfer medium constructed according to the teachings of the present invention, said image transfer medium being represented generally by reference numeral 371.

Image transfer medium 371 comprises an image receiving laminate 373, a first image protecting laminate 375, and a second image protecting laminate 377.

Image receiving laminate 373 comprises a release liner 381, a thermoplastic layer 383 and an ink-receptive layer 385. Release liner 381, which is preferably identical to release liner 113, comprises a base 387 and a release coating 388, release coating 388 being coated directly on top of base 387. Base 387 is preferably identical to base 119, and release coating 388 is preferably identical to release coating 121. Thermoplastic layer 383, which is preferably identical to thermoplastic layer 115, is in direct contact with the top of release coating 388. Ink receptive layer 385, which is deposited directly on top of thermoplastic layer 383, is preferably identical to ink-receptive layer 117.

Image protecting laminate 375 comprises a release liner 390 and a thermoplastic layer 391. Release liner 390, which is preferably identical to release liner 125, includes a base 392 and a release coating 393, release coating 393 being coated directly on top of base 392. Base 392 and coating 393 are preferably identical to base 129 and release coating 130, respectively. Thermoplastic layer 391, which is deposited directly on top of release coating 393, is preferably identical to thermoplastic layer 127.

Image protecting laminate 377 comprises a release liner 394 and a thermoplastic layer 395. Release liner 394, which is preferably identical to release liner 225, includes a base 396 and a release coating 397, release coating 397 being coated directly on top of base 396. Base 396 and coating 397 are preferably identical to base 229 and release coating 230, respectively. Thermoplastic layer 395 is preferably identical to thermoplastic layer 353.

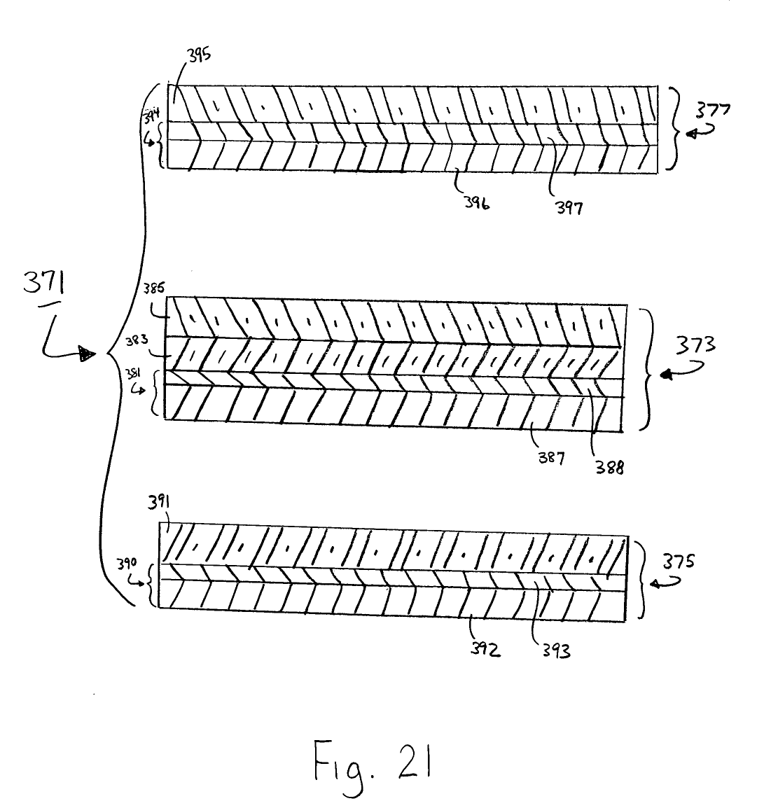

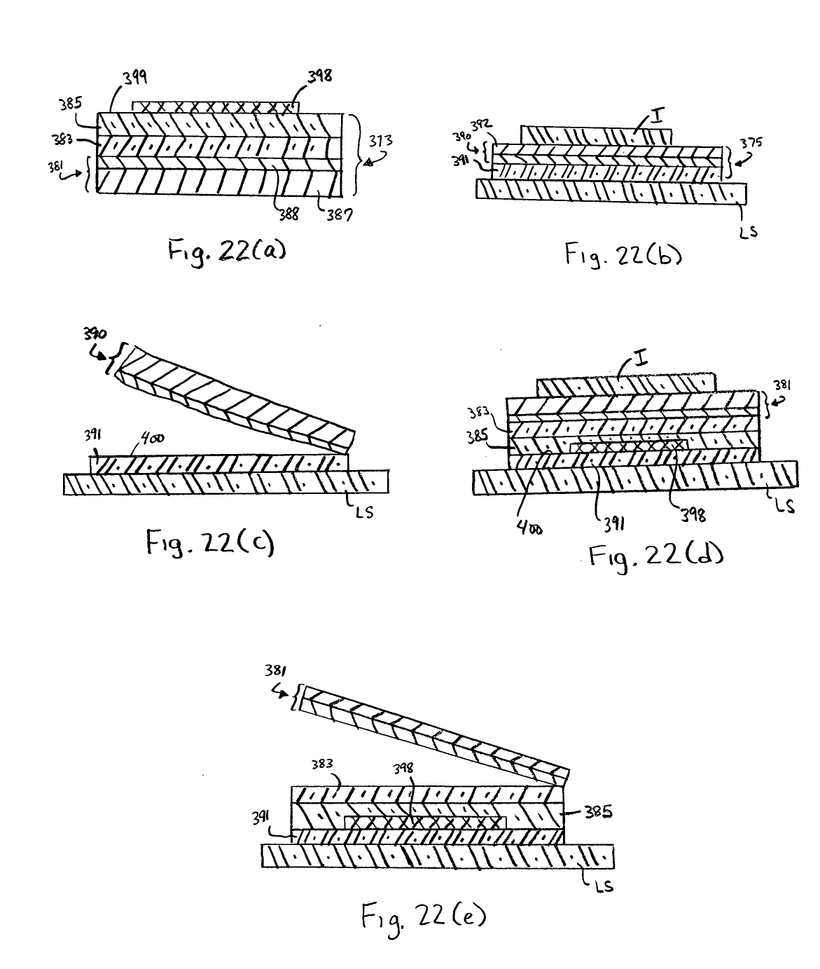

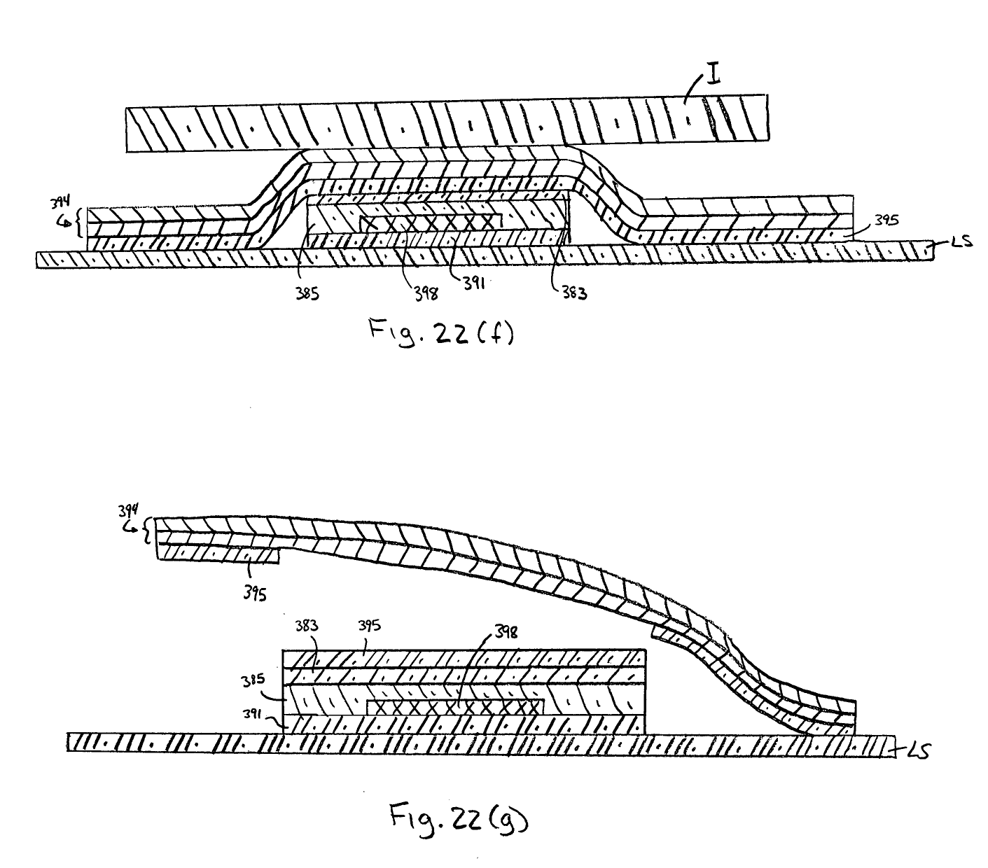

Referring now to FIGS. 22(a) through 22(g), there is shown a series of schematic section views, illustrating one way in which image transfer medium 371 may be used to transfer an image, such as an ink-jet printed image, onto a light-colored (i.e., white) substrate LS, such as a white T-shirt. First, as seen in FIG. 22(a), an image 398 is reverse-printed, preferably using an ink-jet printer, onto a surface 399 of ink-receptive layer 385. Although not shown, image receiving laminate 373 may then be cut to a size matching or slightly greater than image 398, and image protecting laminate 375 may be cut to a size matching or slightly greater than image receiving laminate 373. Next, as seen in FIG. 22(b), thermoplastic layer 391 of image protecting laminate 375 is placed in contact with light-colored substrate LS, and a heat press or household iron I is pressed against release liner base 392 until sufficient heat and pressure are transmitted through release liner 390 to thermoplastic layer 391 to cause thermoplastic layer 391 to bond to light-colored substrate LS. Next, as seen in FIG. 22(c), release liner 390 is peeled away from thermoplastic layer 391, thereby exposing a surface 400 of thermoplastic layer 391. Next, as seen in FIG. 22(d), image 398 is placed, printed face-down, on top of surface 400 of thermoplastic layer 391, and heat press or household iron I is pressed against release liner 381 until sufficient heat and pressure are transmitted to ink-receptive layer 385 (e.g., about 15 to 30 seconds at a temperature of about 140° C.) to cause ink-receptive layer 385 and image 398 to bond to thermoplastic layer 391, thereby sandwiching image 398 between ink-receptive layer 385 and thermoplastic layer 391. Next, as seen in FIG. 22(e), iron I is removed and release liner 381 is peeled away from thermoplastic layer 383. Next, as seen in FIG. 22(f), the exposed surface of thermoplastic layer 395 is placed directly on top of thermoplastic layer 383 and, a heat press or household iron I is pressed against release liner 394 until sufficient heat and pressure are transmitted to thermoplastic layer 395 and to thermoplastic layer 383 (e.g., about 15 to 30 seconds at a temperature of about 140° C.) to cause thermoplastic layer 395 to bond to thermoplastic layer 383. Finally, as seen in FIG. 22(g), after allowing the transfer to cool, release liner 394 is peeled away from that part of thermoplastic layer 395 in contact with thermoplastic layer 383 (the remainder of thermoplastic layer 395 remaining on release liner 394).

One desirable attribute of thermoplastic layer 395 is that thermoplastic layer 395 possesses good “hand.” As a result, thermoplastic layer 395 imparts a soft, tactile property to the transferred laminate.

It should be understood that, instead of bonding thermoplastic layer 391 to light-colored substrate LS and then bonding ink-receptive layer 385 and image 398 to thermoplastic layer 391, one could bond ink-receptive layer 385 and image 398 to thermoplastic layer 391 and then bond thermoplastic layer-391 to light-colored substrate LS or could bond ink-receptive layer 385 and image 398 to thermoplastic layer 391 at the same time thermoplastic layer 391 is bonded to light-colored substrate LS. Where ink-receptive layer 385 and image 398 are bonded to thermoplastic layer 391 prior to bonding thermoplastic layer 391 to light-colored substrate LS, release liner 381 preferably has a higher release value from thermoplastic layer 383 than release liner 390 has from thermoplastic layer 391.

It should also be understood that, instead of using image transfer medium 371 in the manner discussed above, one may alternatively use image transfer medium 371 by direct-printing an image onto ink-receptive layer 385, bonding thermoplastic layer 391 to ink-receptive layer 385 and to the direct-printed image, bonding thermoplastic layer 383 to the substrate (the bonding of thermoplastic layer 391 to ink-receptive layer 385 being either prior to or simultaneous with the bonding of thermoplastic layer 383 to the substrate), and then bonding thermoplastic layer 395 to thermoplastic layer 391.

It should further be understood that one could replace image receiving laminate 373 with any of image receiving laminates 161, 171, 181, 211, 271, 281, 291, 301 and 311.

Referring now to FIGS. 23(a) and 23(b), there are shown schematic section and bottom views, respectively, of a fourth embodiment of an image transfer medium constructed according to the teachings of the present invention, said image transfer medium being represented generally by reference numeral 401.

Image transfer medium 401, which is particularly well-suited for transferring an ink-jet printed image onto a light-colored (i.e., white) substrate, comprises a release liner 403, a first thermoplastic layer 405, a second thermoplastic layer 407 and an ink-receptive layer 409.

Release liner 403 comprises a base 411 and a release coating 413, release coating 413 being coated directly on top of base 411. Base 411 and release coating 413 are preferably identical to base 119 and release coating 121, respectively, of image receiving laminate 111.

First thermoplastic layer 405, which is preferably identical to thermoplastic layer 115 of image receiving laminate 111, is in direct contact with the top of a first portion of release coating 413. Second thermoplastic layer 407, which is preferably identical to thermoplastic layer 127 of image protecting laminate 112, is in direct contact with the top of a second portion of release coating 413. For reasons to become apparent below, second thermoplastic layer 407 preferably has a greater footprint than does first thermoplastic layer 405. Although, in the present embodiment, the inside edges 406 and 408 of thermoplastic layers 405 and 407, respectively, are shown touching one another, inside edges 406 and 408 of thermoplastic layers 405 and 407, respectively, could be spaced apart from one another. Ink-receptive layer 409, which is preferably identical to ink-receptive layer 117 of image receiving laminate 111, is coated directly on top of first thermoplastic layer 405.

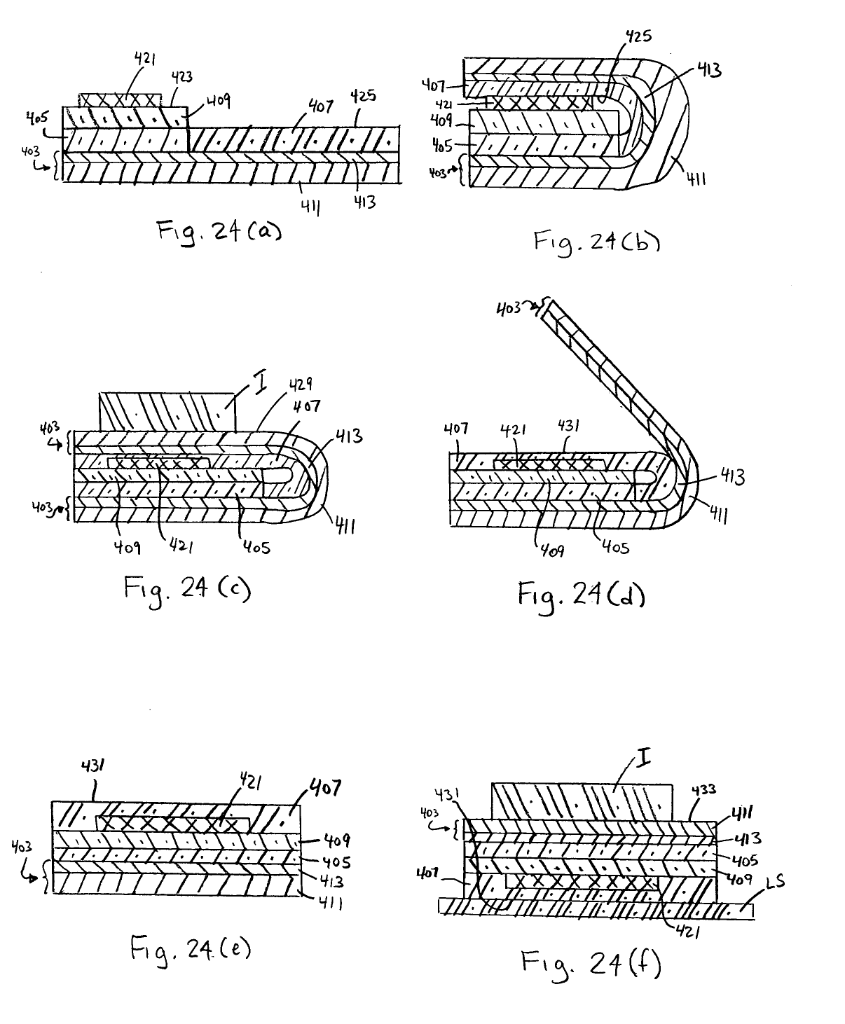

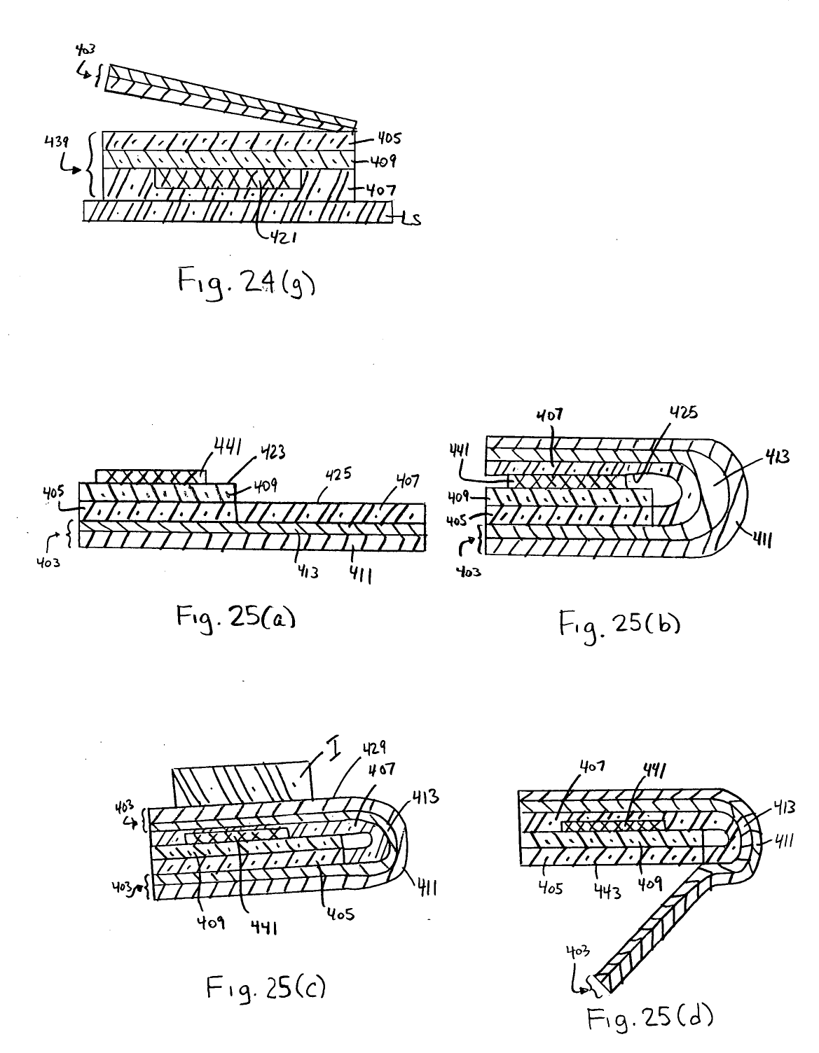

Referring now to FIGS. 24(a) through 24(g), there is shown a series of schematic section views, illustrating a first way in which image transfer medium 401 may be used to transfer an image, such as an ink-jet printed image, onto a light-colored (i.e., white) substrate LS, such as a white T-shirt. First, as seen in FIG. 24(a), an image 421 is reverse-printed, preferably using an ink-jet printer, onto a surface 423 of ink-receptive layer 409. Next, as seen in FIG. 24(b), image transfer medium 401 is folded so that a surface 425 of second thermoplastic layer 407 is positioned directly on top of image 421. Such folding may be facilitated by perforations 427 running along the inner edges of thermoplastic layers 405 and 407 and through release liner 403 (see FIG. 23(b)). (Instead of folding image transfer medium 401 along perforations 427, image transfer medium 401 may be separated into two pieces along perforations 427, with the piece containing second thermoplastic layer 407 then placed over the piece containing image 421.) Next, as seen in FIG. 24(c), heat press or household iron I is pressed against a surface 429 of release liner 403 until sufficient heat and pressure are transmitted through release liner 403 to second thermoplastic layer 407 to cause second thermoplastic layer 407 to bond to image 421 and to ink-receptive layer 409. Next, as seen in FIG. 24(d), release liner 403 is peeled away from second thermoplastic layer 407, thereby exposing a surface 431 of second thermoplastic layer 407. (In order that release liner 403 may be peeled away from second thermoplastic layer 407 and not from first thermoplastic layer 405, release liner 403 preferably has a higher release value to first thermoplastic layer 405 than to second thermoplastic layer 407.) Next, as seen in FIG. 24(e), the assembly is cut to a size slightly greater than image 421. Next, as seen in FIG. 24(f), surface 431 of thermoplastic layer 407 is placed on top of light-colored substrate LS, and heat press or household iron I is pressed against a surface 433 of release liner 403 until sufficient heat and pressure are transmitted to second thermoplastic layer 407 (e.g., about 15 to 30 seconds at a temperature of about 140° C.) to cause second thermoplastic layer 407 to bond to light-colored substrate LS. Finally, as seen in FIG. 24(g), release liner 403 is peeled away from first thermoplastic layer 405, leaving a transferred laminate 439 on light-colored substrate LS.

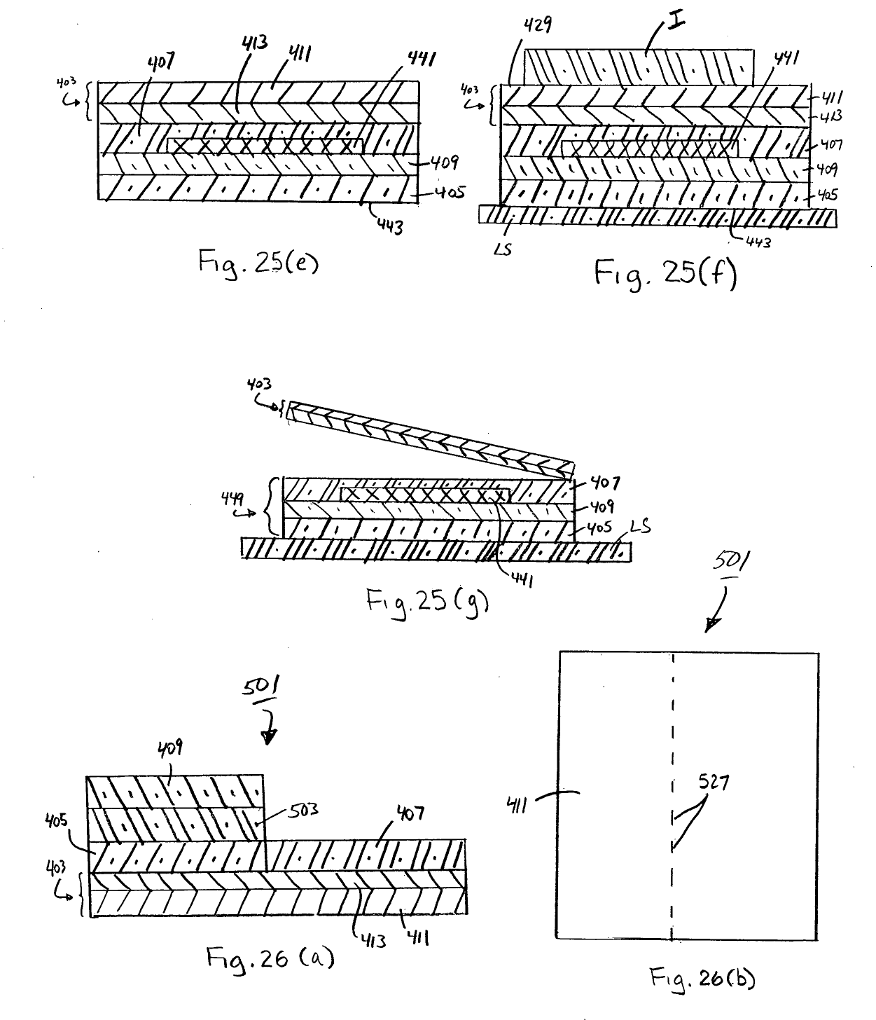

Referring now to FIGS. 25(a) through 25(g), there is shown a series of schematic section views, illustrating a second way in which image transfer medium 401 may be used to transfer an image, such as an ink-jet printed image, onto a light-colored (i.e., white) substrate LS, such as a white T-shirt. First, as seen in FIG. 25(a), an image 441 is direct-printed, preferably using an ink-jet printer, onto a surface 423 of ink-receptive layer 409. Next, as seen in FIG. 25(b), image transfer medium 401 is folded so that a surface 425 of second thermoplastic layer 407 is positioned directly on top of image 441. Such folding may be facilitated by perforations 427 running along the inner edges of thermoplastic layers 405 and 407 and through release liner 403. (Instead of folding image transfer medium 401 along perforations 427, image transfer medium 401 may be separated into two pieces along perforations 427, with the piece containing second thermoplastic layer 407 then placed over the piece containing image 441.) Next, as seen in FIG. 25(c), heat press or household iron I is pressed against a surface 429 of release liner 403 until sufficient heat and pressure are transmitted through release liner 403 to second thermoplastic layer 407 to cause second thermoplastic layer 407 to bond to image 441 and to ink-receptive layer 409. Next, as seen in FIG. 25(d), release liner 403 is peeled away from first thermoplastic layer 405, thereby exposing a surface 443 of first thermoplastic layer 405. (In order that release liner 403 may be peeled away from first thermoplastic layer 405 and not from second thermoplastic layer 407, release liner 403 preferably has a higher release value to second thermoplastic layer 407 than to first thermoplastic layer 405.) Next, as seen in FIG. 25(e), the assembly is cut to a size slightly greater than image 441. Next, as seen in FIG. 25(f), surface 443 of first thermoplastic layer 405 is placed on top of light-colored substrate LS, and heat press or household iron I is pressed against surface 429 of release liner 403 until sufficient heat and pressure are transmitted to first thermoplastic layer 405 (e.g., about 15 to 30 seconds at a temperature of about 140° C.) to cause first thermoplastic layer 405 to bond to light-colored substrate LS. Finally, as seen in FIG. 25(g), release liner 403 is peeled away from second thermoplastic layer 407, leaving a transferred laminate 449 on light-colored substrate LS.

It should be understood that ink-receptive layer 409 of image transfer medium 401 could be replaced with ink-receptive layer 173 and/or that first thermoplastic layer 405 could be omitted from image transfer medium 401, with ink-receptive layer 409 (or ink-receptive layer 173) coated directly onto release coating 413.

Referring now to FIGS. 26(a) and 26(b), there are shown schematic section and top views, respectively, of a fifth embodiment of an image transfer medium constructed according to the teachings of the present invention, said image transfer medium being represented generally by reference numeral 501.

Image transfer medium 501, which is particularly well-suited for transferring an ink-jet printed image onto a dark-colored (i.e., non-white) substrate, is similar in many respects to image transfer medium 401, the principal difference between the two image transfer media being that image transfer medium 501 additionally includes a white layer 503 interposed between first thermoplastic layer 405 and ink-receptive layer 409, white layer 503 preferably being identical to white layer 216 of image receiving laminate 211.

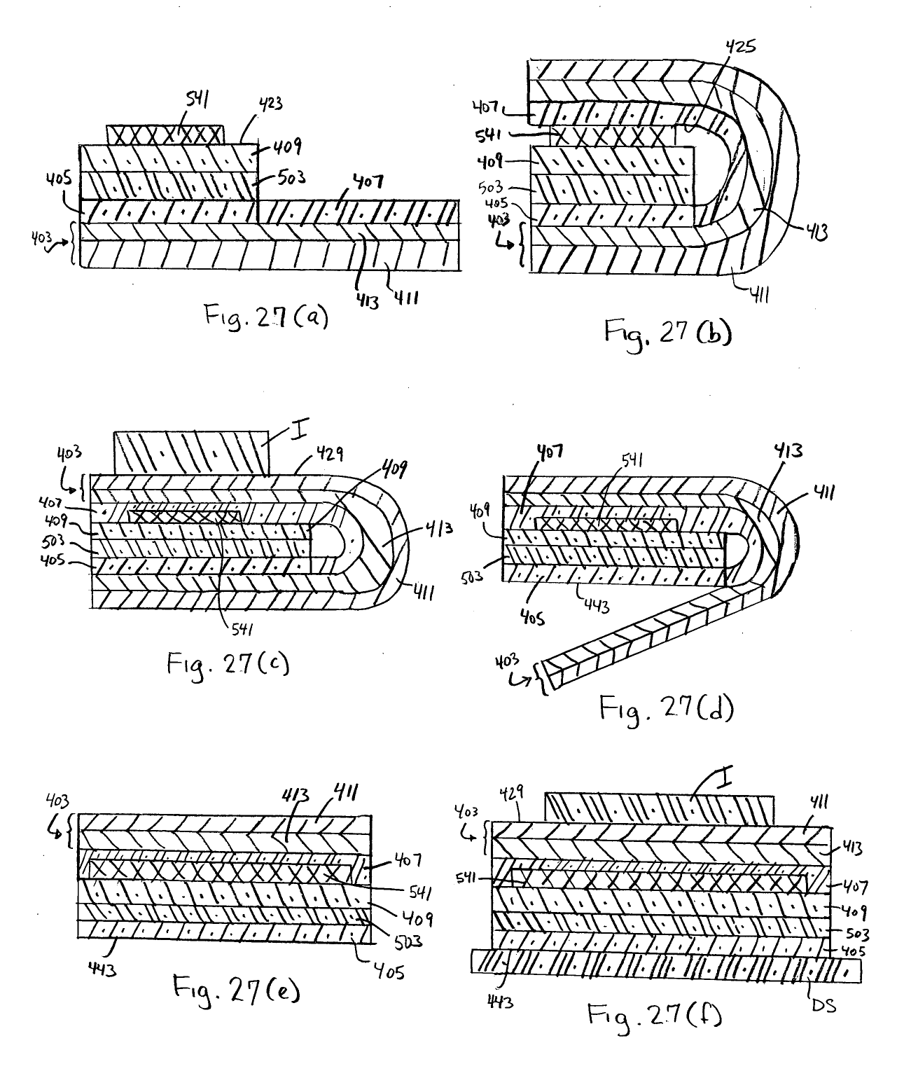

Referring now to FIGS. 27(a) through 27(g), there is shown a series of schematic section views, illustrating a way in which image transfer medium 501 may be used to transfer an image, such as an ink-jet printed image, onto a dark-colored (i.e., non-white) substrate DS, such as a non-white T-shirt. First, as seen in FIG. 27(a), an image 541 is direct-printed, preferably using an ink-jet printer, onto a surface 423 of ink-receptive layer 409. Next, as seen in FIG. 27(b), image transfer medium 501 is folded so that a surface 425 of second thermoplastic layer 407 is positioned directly on top of image 541. Such folding may be facilitated by perforations 527 running along the inner edges of thermoplastic layers 405 and 407 and through release liner 403 (see FIG. 26(b)). (Instead of folding image transfer medium 501 along perforations 527, image transfer medium 501 may be separated into two pieces along perforations 527, with the piece containing second thermoplastic layer 407 then placed over the piece containing image 541.) Next, as seen in FIG. 27(c), heat press or household iron I is pressed against a surface 429 of release liner 403 until sufficient heat and pressure are transmitted through release liner 403 to second thermoplastic layer 407 to cause second thermoplastic layer 407 to bond to image 541 and to ink-receptive layer 409. Next, as seen in FIG. 27(d), release liner 403 is peeled away from first thermoplastic layer 405, thereby exposing a surface 443 of first thermoplastic layer 405. (In order that release liner 403 may be peeled away from first thermoplastic layer 405 and not from second thermoplastic layer 407, release liner 403 preferably has a higher release value to second thermoplastic layer 407 than to first thermoplastic layer 405.) Next, as seen in FIG. 27(e), the assembly is cut to a size slightly greater than image 541. Next, as seen in FIG. 27(f), surface 443 of first thermoplastic layer 405 is placed on top of dark-colored substrate DS, and heat press or household iron I is pressed against surface 429 of release liner 403 until sufficient heat and pressure are transmitted to first thermoplastic layer 405 (e.g., about 15 to 30 seconds at a temperature of about 140° C.) to cause first thermoplastic layer 405 to bond to dark-colored substrate DS. Finally, as seen in FIG. 27(g), release liner 403 is peeled away from second thermoplastic layer 407, leaving a transferred laminate 549 on dark-colored substrate DS.

It should be understood that ink-receptive layer 409 of image transfer medium 501 could be replaced with ink-receptive layer 173 and/or that first thermoplastic layer 405 could be omitted from image transfer medium 501, with ink-receptive layer 409 (or ink-receptive layer 173) positioned directly on release coating 413.

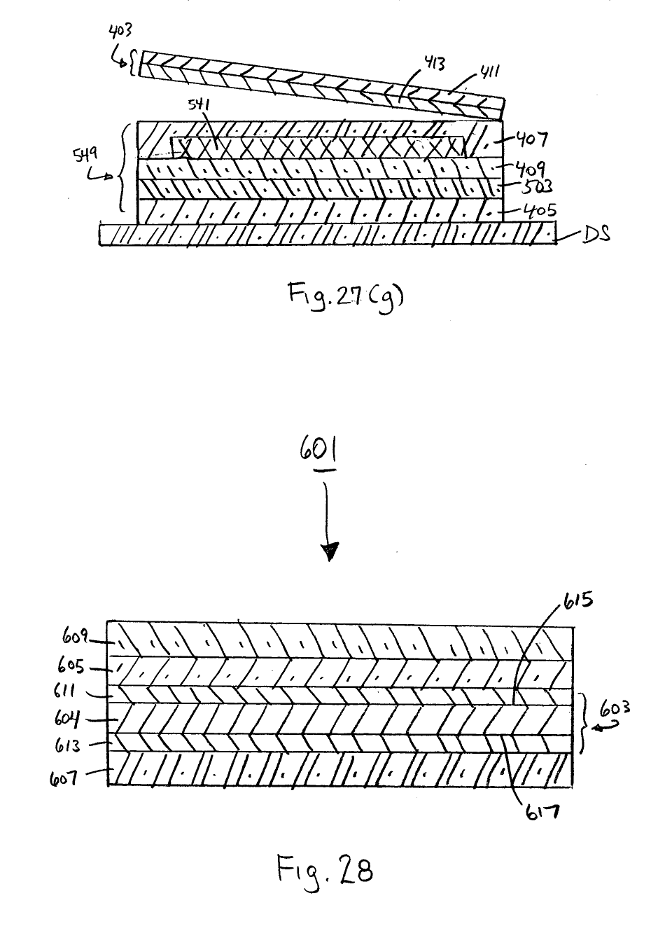

Referring now to FIG. 28, there is shown a schematic section view of a sixth embodiment of an image transfer medium constructed according to the teachings of the present invention, said image transfer medium being represented generally by reference numeral 601.

Image transfer medium 601 comprises a release liner 603, a first thermoplastic layer 605, a second thermoplastic layer 607 and an ink-receptive layer 609.

Release liner 603 comprises a base 604, a first release coating 611 and a second release coating 613, first release coating 611 being coated on a top surface 615 of base 604 and second release coating 613 being coated on a bottom surface 617 of base 604. Base 604 is preferably identical to base 119 of image receiving laminate 111. Although not shown, indicia may be printed on surfaces 615 and/or 617, such indicia including, but not being limited to, instructions for use (e.g., “IRON ON THIS SIDE” printed on surface 615) and/or a trademark or company logo (e.g., printed on surface 617). Surfaces 615 and 617 of base 604 may have the same type of surface finish, such as a matte finish or a glossy finish, or may have different types of finishes. Preferably, top surface 615 has a glossy finish, and bottom surface 617 has a matte finish. First release coating 611 and second release coating 613 may be identical to one another or different from one another and may be the same as or similar to release coating 121. Preferably, release coating 611 has a looser release value than does release coating 613.

First thermoplastic layer 605, which may be identical to first thermoplastic layer 115 of image receiving laminate 111, is in direct contact with release coating 611, and second thermoplastic layer 607, which may be identical to thermoplastic layer 127 of image protecting laminate 112, is in direct contact with release coating 613. If desired, an appropriate pigment may be added to one or both of thermoplastic layers 605 and 607 to facilitate their differentiation. Ink-receptive layer 609, which may be identical to ink-receptive layer 117 of image receiving laminate 111, is positioned directly on top of first thermoplastic layer 605.

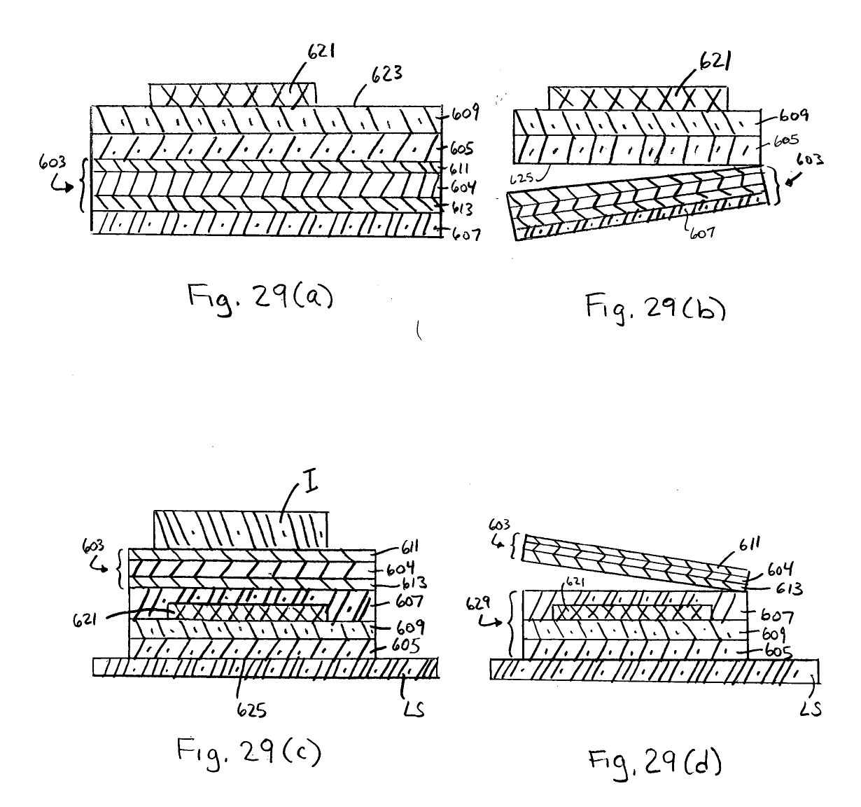

Referring now to FIGS. 29(a) through 29(d), there is shown a series of schematic section views, illustrating a way in which image transfer medium 601 may be used to transfer an image, such as an ink-jet printed image, onto a light-colored (i.e., white) substrate LS, such as a white T-shirt. First, as seen in FIG. 29(a), an image 621 is direct-printed, preferably using an ink-jet printer, onto a surface 623 of ink-receptive layer 609. The assembly may then be cut around image 621. Next, as seen in FIG. 29(b), release liner 603 is peeled away from thermoplastic layer 605, thereby exposing surface 625 of thermoplastic layer 605. Next, as seen in FIG. 29(c), with surface 625 of thermoplastic layer 605 placed in contact with light-colored substrate LS and with thermoplastic layer 607 placed in contact with image 621 and ink-receptive layer 609, heat press or household iron I is pressed against release liner 603 until sufficient heat and pressure are transmitted through release liner 603 to first thermoplastic layer 605 and to second thermoplastic layer 607 (e.g., about 15 to 30 seconds at a temperature of about 140° C.) to cause first thermoplastic layer 605 to bond to light-colored substrate LS and to cause second thermoplastic layer 607 to bond to image 621 and to ink-receptive layer 609. Finally, as seen in FIG. 29(d), release liner 603 is peeled away from second thermoplastic layer 607, leaving a transferred laminate 629 on light-colored substrate LS.

It should be understood that ink-receptive layer 609 of image transfer medium 601 could be replaced with ink-receptive layer 173 and/or that first thermoplastic layer 605 could be omitted from image transfer medium 601, with ink-receptive layer 609 (or ink-receptive layer 173) coated directly onto release coating 611.

Referring now to FIG. 30, there is shown a schematic section view of a seventh embodiment of an image transfer medium constructed according to the teachings of the present invention, said image transfer medium being represented generally by reference numeral 701.

Image transfer medium 701, which is particularly well-suited for transferring an ink-jet printed image onto a dark-colored (i.e., non-white) substrate, is similar in many respects to image transfer medium 601, the principal difference between the two image transfer media being that image transfer medium 701 additionally includes a white layer 703 interposed between first thermoplastic layer 605 and ink-receptive layer 609, white layer 703 preferably being identical to white layer 216 of image receiving laminate 211.

Image transfer medium 701 may be used in a fashion analogous to that disclosed above for image transfer medium 601, image transfer medium 701 being used to transfer a direct-printed image onto a dark-colored (or light-colored) substrate.

It should be understood that ink-receptive layer 609 of image transfer medium 701 could be replaced with ink-receptive layer 173 and/or that first thermoplastic layer 605 could be omitted from image transfer medium 701, with ink-receptive layer 609 (or ink-receptive layer 173) coated directly onto release coating 611.

It should be noted that, with respect to all of the embodiments described above, the thermoplastic layers of the image receiving and image protecting laminates need not be restricted to water-insoluble thermoplastic materials, but rather, may be any of a permanent pressure sensitive adhesive (PSA), a thermoset PSA, a water-soluble thermoplastic polymer and a water-insoluble thermoplastic polymer. By using a permanent PSA, the image could be made repositionable, restickable, and/or easily removable. Such a layer would be particularly suitable for temporary or special applications where images are replaced frequently. It is also ideal for image transfer to thermal sensitive substrates, such as plastics and polymer-coated substrates, and to those having non-planar surfaces, such as bottles, balls, etc. Moreover, for application to washable fabric substrates, the image could be removed before washing so that it would not get lost or damaged during washing and then reapplied after washing. Suitable PSA materials include, but are not limited to, acrylic, natural rubber, synthetic rubber, and silicone-based PSA, with water-borne acrylic-based PSA being preferred. By using a thermoset PSA, one could have the option to change from temporary to permanent transfer, either by heating or over time. Typical thermoset PSA materials comprise epoxy-modified pressure-sensitive adhesives, or an aliphatic amine compound and an acidic polymer, with the transition temperature of the thermoset PSA material being adjusted by modifying the molecular weight of the amine compound. By using a water-soluble thermoplastic polymer, one could obtain the same image properties obtained from normal transfer, such as soft hand touch and fabric appearance, yet be able to remove the image easily by dissolving the polymer, such as by washing or by immersing in water. Examples of suitable water-soluble thermoplastic polymers include gelatin, poly(2-ethyl-oxazoline), polyethylene oxide, polypropylene oxide, polyacrylamide, polyvinyl alcohol, polyvinyl acetate, polyvinyl pyrrolidone and their copolymers and mixtures. Of the above, polyethylene oxide, which preferably has a molecular weight ranging from 100,000 to 8,000,000 Da, is preferred because of its high water solubility.

The following examples are provided for illustrative purposes only and are in no way intended to limit the scope of the present invention:

### EXAMPLE 1A

AVERY DENNISON 3275™ ink-jet T-shirt transfer film (Avery Dennison Corporation, Pasadena, Calif.) was used as an image receiving laminate 111. This image receiving laminate includes a paper-based release liner on which is coated first a thermoplastic layer and then an opaque ink-receptive layer. Hot-melt, extruded polyamide, polyurethane, or polyester films ranging in thickness from 0.001 to 0.010 inch (Adhesive Film Inc., Pine Brook, N.J.) and extruded onto a 4 mil thick paper-based release liner were used as image protecting laminates 112.

An image was reverse-printed onto the ink-receptive layer of the image receiving laminate using an HP PhotoSmart 7350 ink-jet printer. This printer uses a black pigment for black (Cartridge #58) and dye-based inks for all other colors (Cartridge #57). (Unless otherwise noted, this printer and these cartridges were used throughout the Examples.) After printing, the image receiving laminate was cut using scissors along the edges of the printed image. The image protecting laminate was then cut to match the image receiving laminate. In a first experiment, an image protecting laminate comprising a 6 mil thick polyamide film was bonded to a heavyweight 100% cotton fabric (Hanes Corp.) by a Die-bonder machine (Soabar Systems Division, Avery Dennison 79200-00-3) operated at 300° F. and 5 psi for 30 seconds. After peeling off the release liner of the image protecting laminate, the image of the image receiving laminate was placed on, aligned with, and heat bonded to the polyamide film of the image protecting laminate. The release liner of the image receiving laminate was then peeled off. In another experiment, the polyamide film of the image protecting laminate was first bonded to the printed image on the image receiving laminate, and the release liner on the image protecting laminate was then peeled off. After cutting the bonded laminates around the image, the entire assembly was bonded to the fabric, and the release liner was peeled off. In both cases, the transferred image was encapsulated between the polyamide film of the image protective laminate and the ink-receptive layer of the image receiving laminate.

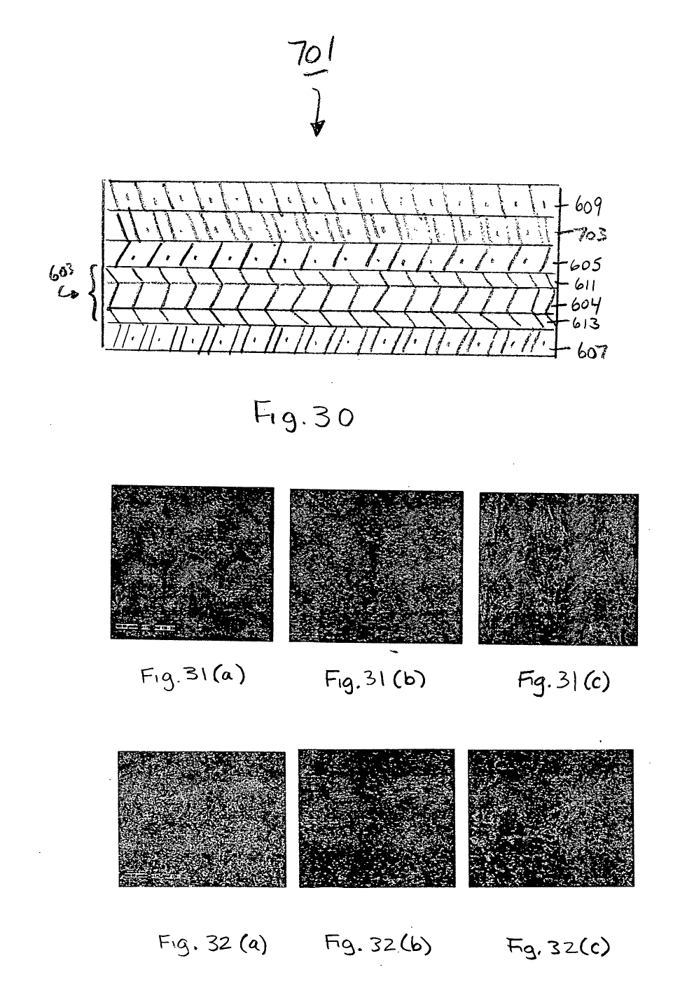

To test the effectiveness of image protection, a thus-prepared sample was washed in a washing machine side-by-side with a sample prepared using only an image receiving laminate (i.e., without the use of an image protecting laminate). The washing conditions were set as Warm/Cold with detergent. The ink losses were monitored using an optical microscope. Pictures were taken from the backside of the fabric right before and after different washing cycles. The results are shown in FIGS. 31 and 32. Prior to image transfer, the pristine fabric substrate had a porous structure (FIG. 31(a)). These pores were filled with inks after image transfer (FIG. 31(b)). After ten washing cycles, however, the inks in the porous areas were completely lost (FIG. 31 (c)). On the other hand, when the polyamide film was bonded to the fabric, the porous areas were completely sealed by the polyamide film (FIG. 32(a)). After ten washing cycles, the porous areas remained filled with inks (FIGS. 32(b) and 32(c)). In addition, although not shown, when looking at the fabrics from the image side, the unsealed sample showed many cracking lines after washing, which cracks were absent from the sealed sample. Similar results were obtained using polyurethane and polyester films in the image protecting laminate.

### EXAMPLE 1B

AVERY DENNISON 3279™ ink-jet dark color T-shirt transfer sheet (Avery Dennison Corporation, Pasadena, Calif.) was used as an image receiving laminate 211. This laminate includes a paper-based release liner, a thermoplastic layer, a white pigment layer, and an ink-receptive layer. An image protecting laminate 212 was made, said image protecting laminate comprising a thermoplastic layer made from an aqueous dispersion of ethylene acrylic acid (EAA) copolymer (Michem 4990R) with 25% solid. A few drops of Zonyl fluorosurfactant (Zonyl FSA, E.I. DuPont) were added to the EAA dispersion to improve its wetting properties. A thermoplastic layer of about 75 μm dry thickness was coated onto a 6 mil thick paper-based release liner (30095 Cast ECR Material, Avery Dennison Corporation) by an Automatic Film Applicator (Elcometer 4340) and dried at 100° C. for 10 min.

An image was direct-printed onto the ink-receptive layer of the image receiving laminate. The release liner was then peeled off from the backside of the image receiving laminate. After cutting around the image, the image receiving laminate was placed on a heavyweight 50/50 dark color fabric (Hanes Corp.). The image protecting laminate was then cut to match the cut-out image. The cut-out image protecting laminate was then placed over the cut-out image and the two were bonded together to the fabric using a heat press (Hix Corp., Model B-820) at 20 psi and 135° C. for 25 seconds. After cooling down, the release liner from the image protecting laminate was peeled off. Washing tests performed under the same set of conditions as in Example 1A resulted in almost no color changes for the present sample whereas color fading was observed for a corresponding sample obtained without using the image protecting laminate. In particular, it was noted that, after washing, the image of the present sample was much more vivid and glossy than the sample obtained without using the image protecting laminate.

### EXAMPLE 1C

A commercially available glow-in-the-dark transfer sheet made by Wausau Papers was used as an image receiving laminate 181. The sheet comprises a paper release liner, a thermoplastic layer, and a glow-in-the-dark ink-receptive layer which produces green light in dark or night conditions. The image protecting laminate of Example 1B was also used.

An image was reverse-printed on the ink-receptive layer. The image receiving laminate was then cut along the edges of the printed image, and the image protecting laminate was then cut to match the image receiving laminate. The image protecting laminate was then bonded to a heavyweight 50/50 fabric using a heat press under 20 psi and 135° C. for 25 seconds. After peeling off the release paper, the image receiving laminate was placed on and bonded to the image protecting laminate. The release paper of the image receiving laminate was then peeled off. The sample was then washed side-by-side with a corresponding sample made without the image protecting laminate. After one wash cycle, the sample made without an image protecting laminate exhibited severe cracking over the entire image whereas the sample made with the image protecting laminate did not show any change. Clearly, the image protecting laminate improved the cracking resistance of the transferred image.

### EXAMPLE 2

AVERY DENNISON 3275™ ink-jet light color T-shirt transfer sheet was used as an image receiving laminate 11. An acrylic-based 2 mil thick pressure-sensitive adhesive (PSA) film made by Avery Performance Polymer (Avery Dennison, S-2001) was used as the image protecting laminate. The PSA film was laminated between two paper release liners having different release properties. An image was reverse-printed on the image receiving laminate. The laminate was cut around the image and the cut-out image was attached to a heavyweight 50/50 fabric (Hanes Corp.) by the PSA. Heat was applied to the backside of the image receiving laminate to thermally convert the ink-receptive layer from opaque to transparent state. The release liner was then peeled off. The image thus transferred held firmly to the T-shirt, yet could be peeled off easily without leaving any residues. The image could also be removed cleanly by washing.

### EXAMPLE 3

Small images of 2″×3″ were reverse-printed onto the ink-receptive layer of an image receiving laminate of the type described in Example 1A. The images were then cut out. A low molecular weight polyethylene oxide (POLYOX® N80, Dow Chemical) solution was prepared in deionized water with 20% solid. The solution was coated onto a 6 mil thick silicone-coated paper release liner (Avery Dennison, 30095 Cast ECR Material) using the Automatic Film Applicator and dried at 100° C. for 10 min. The final dry film thickness of the polyethylene oxide layer was about 60 μm. Small samples of 2″×3″ were cut out of the polyethylene oxide containing laminate and bonded to a heavyweight 50/50 fabric (Hanes Corp.) by the Die-bonder machine operated at a pressure of 5 psi. Different temperatures ranging from 220° F. to 300° F. and bonding durations were used. After cooling down, the release liners were peeled off. The cut-out images were then placed over and bonded to the polyethylene oxide films under exactly the same transfer conditions. The images transferred at 220° F./30 s, 240° F./10 s, and 240° F./30 s were comparable to those obtained without using an image protecting laminate. These samples were washed in a washing machine set at Warm/Cold with detergent. After one wash, all of the images were removed cleanly, no ghost inks were observed.

### EXAMPLE 4

An image was direct-printed onto an image receiving laminate of the type generally identified above as image receiving laminate 111, the ink-receptive layer of said image receiving laminate being of the type disclosed in U.S. Pat. No. 6,153,288, which is incorporated herein by reference. The image receiving laminate was then bonded to a heavyweight 50/50 fabric (Hanes Corp.) by a household iron via the thermoplastic layer. An image protecting laminate of the type described above in Example 1B was placed over and bonded to the image via the EAA film of the image protecting laminate. The release liner was then peeled off. Comparative washing tests were performed with samples made without using an image protecting laminate. The washing machine was set as Warm/Cold with detergent. After 1 washing cycle, the EAA film delaminated from the image, probably because the EAA film was too thin and did not have good contact with the textured image surface. Nevertheless, the image remained almost unchanged after 5 washes whereas the sample made without using an image protecting laminate faded in color and exhibited many white spots, which were likely due to localized image peel off.

### EXAMPLE 5

An image transfer medium like image transfer medium 401 was prepared as follows: an aqueous dispersion of ethylene acrylic acid copolymer (Michem 4990R) with 25% solid, as described in Example 1B, was coated on a first half of a 6 mil thick silicone paper release liner (Avery Dennison, 30095 Cast ECR Material) using an Automatic Film Applicator and then dried at 100° C. for 10 min to yield a first thermoplastic layer having a dry coating thickness of about 10 μm. The same material was then coated onto a second half of the release liner to yield a second thermoplastic layer having a dry coating thickness of about 40 μm. An ink-receptive formulation was prepared by mixing 4 g of Orgasol 3502 D NAT (Atofina North America), 4 g of POLYOX® N750 (Dow Chemical) with 10% solid, 4 g of deionized water, and 1 drop of Zonyl FSA (E.I. DuPont). This formulation was then coated over the first thermoplastic layer to yield an ink-receptive layer having a dry coating thickness of about 75 μm.

An image was then reverse-printed onto the ink-receptive layer. The second thermoplastic layer was then folded over the image. A household iron was then used to bond the thermoplastic layer to the image-receptive layer. After cooling down, the release liner from the second thermoplastic layer was peeled off. The bonded assembly was then cut around the image. The cut-out assembly was then placed on and bonded to a heavyweight 50/50 fabric (Hanes Corp.) by a household iron. The release liner was then peeled off.

To evaluate the effectiveness of image protection, an image was also reverse-printed and subsequently transferred to a light-colored fabric without folding over the second thermoplastic layer to protect the image. Washing tests were performed to compare the durability of the protected and unprotected samples. Both samples showed surprising color retention after 10 washing cycles. However, the unprotected sample showed micro-wrinkles over the entire film after the first wash, which micro-wrinkles remained after 10 washes. The protected sample, on the other hand, did not exhibit any changes after 10 washes. It is believed that the formation of micro-wrinkles in the unprotected sample was caused by the dissolution of water soluble polyethylene oxide binder in the porous areas.

### EXAMPLE 6

An image transfer medium like image transfer medium 601 was prepared as follows: a double-sided release liner was obtained from Loparex Corp. (Willowbrook, Ill.). The liner comprises a 5.7 mil thick paper substrate having a smooth, glossy finish top surface and a textured, matte bottom surface. The top surface has a release coating with a loose release value and the bottom surface has a release coating with a tight release value. The top surface was coated with a first thermoplastic layer in the form of a 40 μm thick EAA film of the type described in Example 1B. The bottom surface was coated with a second thermoplastic layer in the form of a 10 μm thick EAA film of the type described above in Example 1B. An ink-receptive layer having a dry 75 μm dry thickness was coated over the first thermoplastic layer, the ink-receptive layer comprising a mixture of 4 g of Orgasol 3502 D NAT, 4 g of POLYOX® N750 with 10% solid, 4 g of deionized water, and 1 drop of FSA.

An image was direct-printed on the ink-receptive surface. After cutting around the image, the release liner was peeled off at the interface between the loose release surface and the first thermoplastic layer. The release liner thus peeled off had the second thermoplastic layer on the bottom, matte surface. The cut-out image was placed on the substrate, and the peeled, cut-out release liner was placed over the image. Heat was applied to bond simultaneously the second thermoplastic layer to the image and the first thermoplastic layer to the substrate. The release liner was then peeled away from the second thermoplastic layer.

Comparative washing tests performed on the above-described sample and an unprotected sample exhibited similar results to that obtained in Example 5.

### EXAMPLE 7

AVERY DENNISON 3279™ ink-jet dark color T-shirt transfer sheet (Avery Dennison Corporation, Pasadena, Calif.) was used as an image receiving laminate 211. An image protecting laminate like image protecting laminate 351 was made, said image protecting laminate comprising a thermoplastic layer made from a composition comprising 5 g of 1% POLYOX® 301 polyethylene oxide solution in deionized water (Dow Chemical), 0.1 g Tafigel Pur 61 thickener (Ultra Additives), 3 g of GEON® 213 PVC particles (PolyOne), 2 g of Witcobond-213 cationic urethane polymer dispersion (Crompton, N.J.) and 0.5 g of a 1:1 weight ratio mixture of benzyl butyl phthalate (Aldrich) and dioctyl phthalate (Eastman Chemical) plasticizers. Surfactants and defoamers were added to the above formulation to improve its wetting properties. A few drops of ammonia concentrate were added to the above formulation to adjust the pH to about 7. A thermoplastic layer of about 50 μm dry thickness was coated onto a polyethylene terephthalate (PET) release liner by an Automatic Film Applicator (Elcometer 4340) and dried at 100° C. for 10 min.

An image was direct-printed onto the ink-receptive layer of the image receiving laminate. The release liner was then peeled off from the backside of the image receiving laminate. After cutting around the image, the image receiving laminate was placed on a dark colored, heavyweight, 100% cotton fabric (Hanes Corp.). The image protecting laminate was then placed over the image receiving laminate, the image protecting laminate extending over the entirety of the image receiving laminate and a surrounding area of the dark color cotton fabric. Then, using a heat press under the same conditions described above in Example 1B, the image protecting laminate was bonded to the image receiving laminate, and the image receiving laminate was bonded to the fabric. After cooling down, the release liner from the image protecting laminate was peeled off. The portion of the thermoplastic layer of the image protecting laminate in contact with the printed image and the ink-receptive layer of the image receiving laminate remained bonded thereto whereas the remainder of the thermoplastic layer was peeled off with the release liner.

The embodiments of the present invention recited herein are intended to be merely exemplary and those skilled in the art will be able to make numerous variations and modifications to it without departing from the spirit of the present invention. All such variations and modifications are intended to be within the scope of the present invention as defined by the claims appended hereto.

What is claimed is:

1. An image transfer medium comprising:
(a) an image receiving laminate, the image receiving laminate comprising
(i) a first release liner; and
(ii) an ink-receptive layer for receiving an image, the ink-receptive layer being releasably bonded to the first release liner; and
(b) a first image protecting laminate, the first image protecting laminate comprising
(i) a second release liner; and
(ii) a first protective layer releasably bonded to the second release liner, the first protective layer being bondable to the ink-receptive layer.

2. The image transfer medium as claimed in claim 1 wherein the first release liner comprises a first base and a first release coating, the first release coating being positioned between the first base and the ink-receptive layer.

3. The image transfer medium as claimed in claim 2 wherein the first release coating is applied directly to a first surface of the first base.

4. The image transfer medium as claimed in claim 3 wherein the first surface of the first base is smooth.

5. The image transfer medium as claimed in claim 1 wherein the ink-receptive layer comprises a polymeric binder and dispersed polymeric particles held in place by the polymeric binder.

6. The image transfer medium as claimed in claim 1 wherein the ink-receptive layer is opaque and becomes transparent with image transfer.

7. The image transfer medium as claimed in claim 1 wherein the ink-receptive layer comprises a white pigment.

8. The image transfer medium as claimed in claim 1 wherein the ink-receptive layer comprises a glow-in-the-dark pigment.

9. The image transfer medium as claimed in claim 1 wherein the ink-receptive layer comprises a thermochromic pigment.

10. The image transfer medium as claimed in claim 1 wherein the ink-receptive layer comprises a combination of water-soluble and water-insoluble pigments, the combination of water-soluble and water-insoluble pigments being selected such that the ink-receptive layer changes color upon exposure to water.

11. The image transfer medium as claimed in claim 1 wherein the ink-receptive layer is in direct contact with the first release liner.

12. The image transfer medium as claimed in claim 1 wherein the image receiving laminate further comprises a first layer interposed between the release liner and the ink-receptive layer, the ink-receptive layer being permanently bonded to the first layer, the first layer being releasably bonded to the release liner.

13. The image transfer medium as claimed in claim 12 wherein the ink-receptive layer further comprises a pigment.

14. The image transfer medium as claimed in claim 12 wherein the first layer comprises a pigment and a polymeric binder.

15. The image transfer medium as claimed in claim 14 wherein the pigment is a white inorganic pigment.

16. The image transfer medium as claimed in claim 12 wherein the first layer is in direct contact with the release liner.

17. The image transfer medium as claimed in claim 12 wherein the image receiving laminate further comprises a thermoplastic layer interposed between the release liner and the first layer, the first layer being bonded to the thermoplastic layer, the thermoplastic layer being releasably bonded to the release liner.

18. The image transfer medium as claimed in claim 17 wherein the thermoplastic layer is water-insoluble.

19. The image transfer medium as claimed in claim 17 wherein the thermoplastic layer is in direct contact with the release liner.

20. The image transfer medium as claimed in claim 12 wherein the first layer is a thermoplastic layer.

21. The image transfer medium as claimed in claim 20 wherein the first layer is in direct contact with the ink-receptive layer.

22. The image transfer medium as claimed in claim 21 wherein the thermoplastic layer is water-insoluble.

23. The image transfer medium as claimed in claim 14 wherein first layer comprises a pressure-sensitive adhesive.

24. The image transfer medium as claimed in claim 23 wherein the pressure-sensitive adhesive is a permanent pressure-sensitive adhesive.

25. The image transfer medium as claimed in claim 23 wherein the pressure-sensitive adhesive is a thermoset pressure-sensitive adhesive.

26. The image transfer medium as claimed in claim 23 wherein the first layer is in direct contact with the ink-receptive layer.

27. The image transfer medium as claimed in claim 23 wherein the image receiving laminate further comprises a white layer interposed between the ink-receptive layer and the first layer.

28. The image transfer medium as claimed in claim 1 wherein the first protective layer is in direct contact with the second release liner.

29. The image transfer medium as claimed in claim 1 wherein the first protective layer comprises a thermoplastic polymer.

30. The image transfer medium as claimed in claim 29 wherein the thermoplastic polymer is water-insoluble.

31. The image transfer medium as claimed in claim 1 wherein the first protective layer comprises a pressure-sensitive adhesive.

32. The image transfer medium as claimed in claim 31 wherein the pressure-sensitive adhesive is a permanent pressure-sensitive adhesive.

33. The image transfer medium as claimed in claim 31 wherein the pressure-sensitive adhesive is a thermoset pressure-sensitive adhesive.

34. The image transfer medium as claimed in claim 1 wherein the second release liner comprises a first base and a first release coating, the first release coating of the second release liner being positioned between the first base of the second release liner and the first protective layer.

35. The image transfer medium as claimed in claim 34 wherein the first release coating of the second release liner is applied directly to a first surface of the first base of the second release liner.

36. The image transfer medium as claimed in claim 35 wherein the first surface of the first base of the second release liner is smooth.

37. The image transfer medium as claimed in claim 1 wherein the first protective layer is transparent with image transfer.

38. The image transfer medium as claimed in claim 1 wherein the first protective layer comprises a polyethylene oxide, polyvinyl chloride particles, a cationic urethane polymer, and at least one plasticizer.

39. The image transfer medium as claimed in claim 1 further comprising a second image protecting laminate, the second image protecting laminate comprising
(i) a third release liner; and
(ii) a second protective layer releasably bonded to the third release liner, the second protective layer being bondable to the first protective layer.

40. The image transfer medium as claimed in claim 39 wherein the second protective layer comprises a polyethylene oxide, polyvinyl chloride particles, a cationic urethane polymer, and at least one plasticizer.

41. A method of transferring an image to a light-colored substrate, the method comprising the steps of:
(a) providing the image transfer medium of claim 6;
(b) reverse-printing an image onto the ink-receptive layer;
(c) bonding the first protective layer to the ink-receptive layer, whereby the image is sandwiched between the first protective layer and the ink-receptive layer; and
(d) bonding the first protective layer to the light-colored substrate, the first protective layer being positioned between the image and the light-colored substrate.

42. The method as claimed in claim 41 wherein the image is an ink-jet image.

43. The method as claimed in claim 41 wherein step (d) is performed before step (c).

44. The method as claimed in claim 41 wherein steps (c) and (d) are performed simultaneously.

45. A method of transferring an image to a light-colored substrate, the method comprising the steps of:
(a) providing the image transfer medium of claim 37;
(b) direct-printing an image onto the ink-receptive layer;
(c) bonding the first protective layer to the ink-receptive layer, whereby the image is sandwiched between the first protective layer and the ink-receptive layer; and
(d) bonding the ink-receptive layer to the light-colored substrate, the ink-receptive layer being positioned between the image and the light-colored substrate.

46. The method as claimed in claim 45 wherein the image is an ink-jet image.

47. The method as claimed in claim 45 wherein step (d) is performed before step (c).

48. The method as claimed in claim 45 wherein steps (c) and (d) are performed simultaneously.

49. The method as claimed in claim 45 wherein step (d) comprises directly bonding the ink-receptive layer to the light-colored substrate.

50. The method as claimed in claim 45 wherein the first protective layer is formulated to selectively bond to the ink-receptive layer and not to the light-colored substrate.

51. A method of transferring an image to a substrate, the method comprising the steps of:
(a) providing the image transfer medium of claim 7;
(b) direct-printing an image onto the ink-receptive layer;
(c) bonding the first protective layer to the ink-receptive layer, whereby the image is sandwiched between the first protective layer and the ink-receptive layer; and
(d) bonding the ink-receptive layer to the substrate, the ink-receptive layer being positioned between the image and the substrate.

52. The method as claimed in claim 51 wherein the image is an ink-jet image.

53. The method as claimed in claim 51 wherein step (d) is performed before step (c).

54. The method as claimed in claim 51 wherein steps (c) and (d) are performed simultaneously.

55. The method as claimed in claim 51 wherein step (d) comprises directly bonding the ink-receptive layer to the substrate.

56. The method as claimed in claim 51 wherein the substrate is dark-colored.

57. The method as claimed in claim 51 wherein the substrate is light-colored.

58. The method as claimed in claim 51 wherein the first protective layer is formulated to selectively bond to the ink-receptive layer and not to the substrate.

59. A method of transferring an image to a substrate, the method comprising the steps of:
(a) providing the image transfer medium of claim 15;
(b) direct-printing an image onto the ink-receptive layer;
(c) bonding the first protective layer to the ink-receptive layer, whereby the image is sandwiched between the first protective layer and the ink-receptive layer; and
(d) bonding the ink-receptive layer to the substrate, the ink-receptive layer being positioned between the image and the substrate.

60. The method as claimed in claim 59 wherein the image is an ink-jet image.

61. The method as claimed in claim 59 wherein step (d) is performed before step (c).

62. The method as claimed in claim 59 wherein steps (c) and (d) are performed simultaneously.

63. The method as claimed in claim 59 wherein step (d) comprises directly bonding the ink-receptive layer to the substrate.

64. The method as claimed in claim 59 wherein the substrate is dark-colored.

65. The method as claimed in claim 59 wherein the substrate is light-colored.

66. The method as claimed in claim 59 wherein the first protective layer is formulated to selectively bond to the ink-receptive layer and not to the substrate.

67. A method of transferring an image to a substrate, the method comprising the steps of:
(a) providing the image transfer medium of claim 39;
(b) printing an image onto the ink-receptive layer;
(c) bonding the first protective layer to the ink-receptive layer, whereby the image is sandwiched between the first protective layer and the ink-receptive layer;
(d) bonding one of the ink-receptive layer and the first protective layer to the substrate;
(e) bonding the second protective layer to the other of the ink-receptive layer and the first protective layer.

68. The method as claimed in claim 67 wherein the second protective layer comprises a polyethylene oxide, polyvinyl chloride particles, a cationic urethane polymer, and at least one plasticizer.

69. An image transfer medium comprising:
(a) a release liner;
(b) an ink-receptive layer for receiving an image, the ink-receptive layer being releasably bonded to a first area of the release liner; and
(c) a protective layer, the protective layer being releasably bonded to a second area of the release liner, the protective layer being bondable to the ink-receptive layer.

70. The image transfer medium as claimed in claim 68 wherein the ink-receptive layer is transparent.

71. The image transfer medium as claimed in claim 69 wherein the ink-receptive layer comprises a white pigment.

72. The image transfer medium as claimed in claim 69 wherein the ink-receptive layer comprises a glow-in-the-dark pigment.

73. The image transfer medium as claimed in claim 69 wherein the ink-receptive layer comprises a thermochromic pigment.

74. The image transfer medium as claimed in claim 69 wherein the ink-receptive layer comprises a combination of water-soluble and water-insoluble pigments, the combination of water-soluble and water-insoluble pigments being selected such that the ink-receptive layer changes color upon exposure to water.

75. The image transfer medium as claimed in claim 69 wherein the ink-receptive layer is in direct contact with the release liner.

76. The image transfer medium as claimed in claim 69 further comprising a white layer interposed between the ink-receptive layer and the release liner, the ink-receptive layer being securely bonded to the white layer, the white layer being releasably bonded to the release liner.

77. The image transfer medium as claimed in claim 76 wherein the white layer is in direct contact with the release liner.

78. The image transfer medium as claimed in claim 76 further comprising a thermoplastic layer interposed between the release liner and the white layer, the white layer being securely bonded to the thermoplastic layer, the thermoplastic layer being releasably bonded to the release liner.

79. The image transfer medium as claimed in claim 78 wherein the thermoplastic layer is in direct contact with the release liner.

80. The image transfer medium as claimed in claim 78 wherein the first area of the release liner and the second area of the release liner are located on the same surface of the release liner.

81. The image transfer medium as claimed in claim 69 further comprising a thermoplastic layer interposed between the ink-receptive layer and the release liner, the ink-receptive layer being bonded to the thermoplastic layer, the thermoplastic layer being releasably bonded to the release liner.

82. The image transfer medium as claimed in claim 81 wherein the thermoplastic layer is in direct contact with each of the ink-receptive layer and the release liner.

83. The image transfer medium as claimed in claim 81 wherein the thermoplastic layer comprises a water-insoluble thermoplastic polymer.

84. The image transfer medium as claimed in claim 81 wherein the thermoplastic layer comprises a water-soluble thermoplastic polymer.

85. The image transfer medium as claimed in claim 81 wherein the first area of the release liner and the second area of the release liner are located on the same surface of the release liner.

86. The image transfer medium as claimed in claim 69 further comprising a pressure-sensitive adhesive layer interposed between the ink-receptive layer and the release liner, the ink-receptive layer being bonded to the pressure-sensitive adhesive layer, the pressure-sensitive adhesive layer being releasably bonded to the release liner.

87. The image transfer medium as claimed in claim 86 wherein the pressure-sensitive adhesive layer comprises a permanent pressure-sensitive adhesive.

88. The image transfer medium as claimed in claim 86 wherein the pressure-sensitive adhesive layer comprises a thermoset pressure-sensitive adhesive.

89. The image transfer medium as claimed in claim 69 wherein the protective layer is transparent.

90. The image transfer medium as claimed in claim 69 wherein the first area of the release liner and the second area of the release liner are located on the same surface of the release liner.

91. The image transfer medium as claimed in claim 69 wherein the release liner is double-sided and wherein the first area of the release liner and the second area of the release liner are located on opposite surfaces of the release liner.

92. The image transfer medium as claimed in claim 91 wherein the protective layer is more tightly secured to the release liner than the ink-receptive layer is secured to the release liner.

93. The image transfer medium as claimed in claim 91 further comprising a white layer interposed between the ink-receptive layer and the release liner, the ink-receptive layer being securely bonded to the white layer, the white layer being releasably bonded to the release liner.

94. A method of transferring an image to a light-colored substrate, the method comprising the steps of:
(a) providing the image transfer medium of claim 70;
(b) reverse-printing an image onto the ink-receptive layer;
(c) bonding the protective layer to the ink-receptive layer, whereby the image is sandwiched between the protective layer and the ink-receptive layer; and
(d) bonding the protective layer to the light-colored substrate, the protective layer being positioned between the image and the light-colored substrate.

95. The method as claimed in claim 94 wherein the image is an ink-jet image.

96. The method as claimed in claim 94 wherein step (c) is performed before step (d).

97. The method as claimed in claim 94 further comprising, after step (b) and before step (c), the step of folding the release liner so that the image is sandwiched between the protective layer and the ink-receptive layer.

98. The method as claimed in claim 94 further comprising, after step (b) and before step (c), the step of removing the ink-receptive layer from the release liner and re-positioning the ink-receptive layer so that the image is sandwiched between the ink-receptive layer and the protective layer.

99. A method of transferring an image to a light-colored substrate, the method comprising the steps of:
(a) providing the image transfer medium of claim 89;
(b) direct-printing an image onto the ink-receptive layer;
(c) bonding the protective layer to the ink-receptive layer, whereby the image is sandwiched between the protective layer and the ink-receptive layer; and
(d) bonding the ink-receptive layer to the light-colored substrate, the ink-receptive layer being positioned between the image and the light-colored substrate.

100. The method as claimed in claim 99 wherein step (d) comprises bonding the ink-receptive layer directly to the light-colored substrate.

101. The method as claimed in claim 99 wherein the image is an ink-jet image.

102. The method as claimed in claim 99 wherein step (c) is performed before step (d).

103. The method as claimed in claim 99 further comprising, after step (b) and before step (c), the step of folding the release liner so that the image is sandwiched between the protective layer and the ink-receptive layer.

104. The method as claimed in claim 99 further comprising, after step (b) and before step (c), the step of removing the ink-receptive layer from the release liner and re-positioning the ink-receptive layer so that the image is sandwiched between the ink-receptive layer and the protective layer.

105. A method of transferring an image to a substrate, the method comprising the steps of:
(a) providing the image transfer medium of claim 71;
(b) direct-printing an image onto the ink-receptive layer;
(c) bonding the protective layer to the ink-receptive layer, whereby the image is sandwiched between the protective layer and the ink-receptive layer; and
(d) bonding the ink-receptive layer to the substrate, the ink-receptive layer being positioned between the image and the substrate.

106. The method as claimed in claim 105 wherein step (d) comprises bonding the ink-receptive layer directly to the substrate.

107. The method as claimed in claim 105 wherein the substrate is a dark-colored substrate.

108. A method of transferring an image to a substrate, the method comprising the steps of:
(a) providing the image transfer medium of claim 76;
(b) direct-printing an image onto the ink-receptive layer;
(c) bonding the protective layer to the ink-receptive layer, whereby the image is sandwiched between the protective layer and the ink-receptive layer; and
(d) bonding the ink-receptive layer to the substrate, the ink-receptive layer being positioned between the image and the substrate.

109. The method as claimed in claim 108 wherein step (d) comprises bonding the white layer directly to the substrate.

110. The method as claimed in claim 108 wherein the substrate is a dark-colored substrate.

111. A method of transferring an image to a light-colored substrate, the method comprising the steps of:
(a) providing the image transfer medium of claim 91;
(b) then, direct-printing an image onto the ink-receptive layer;
(c) then, separating the ink-receptive layer from the release liner;
(d) then, bonding the protective layer to the ink-receptive layer, whereby the image is sandwiched between the protective layer and the ink-receptive layer; and
(e) bonding the ink-receptive layer to the light-colored substrate, the ink-receptive layer being positioned between the image and the light-colored substrate.

112. The method as claimed in claim 111 wherein step (d) is performed before step (e).

113. The method as claimed in claim 111 wherein steps (d) and (e) are performed simultaneously.

114. A method of transferring an image to a substrate, the method comprising the steps of:
(a) providing the image transfer medium of claim 93;
(b) then, direct-printing an image onto the ink-receptive layer;
(c) then, separating the ink-receptive layer and the white layer from the release liner;
(d) then, bonding the protective layer to the ink-receptive layer, whereby the image is sandwiched between the protective layer and the ink-receptive layer; and
(e) bonding the white layer to the substrate, the white layer being positioned between the image and the substrate.

115. The method as claimed in claim 114 wherein step (d) is performed before step (e).

116. The method as claimed in claim 114 wherein steps (d) and (e) are performed simultaneously.
